(19) United States
(12) Patent Application Publication
(10) Pub. No.: US 2026/0080605 A1
(43) Pub. Date: Mar. 19, 2026

(54) Highly Compressed Triangles

(71) Applicant: NVIDIA Corporation, Santa Clara, CA (US)

(72) Inventors: Gregory MUTHLER, Chapel Hill, NC (US); John BURGESS, Austin, TX (US); Yury URALSKY, Los Gatos, CA (US); Andrea MAGGIORDOMO, Lund (SE); Henry MORETON, Woodside, CA (US); Christoph KUBISCH, Aachen (DE); Steven PARKER, Draper, UT (US); Mitch HAYENGA, Austin, TX (US)

(21) Appl. No.: 18/990,691

(22) Filed: Dec. 20, 2024

Related U.S. Application Data
(60) Provisional application No. 63/695,327, filed on Sep. 16, 2024.

(51) Int. Cl. G06T 15/06; G06T 17/20

(52) U.S. Cl. CPC G06T 15/06; G06T 17/205; G06T 2210/21

(57) ABSTRACT

Raytracing and pathtracing systems use vertex compression including per-component shifts, unsigned arithmetic deltas, and base vertex shortening. Topology encodings include enhanced explicit vertex indexing and implicit triangle strip based indexing including left, right, start tokens, turn back, and degenerate tokens and including rotation. Substantial lossless compression ratio increases are realized, especially for highly quantized vertex data.

### CROSS-REFERENCE TO RELATED APPLICATIONS

Benefit is claimed from U.S. application No. 63/695,327 filed Sep. 16, 2024, incorporated herein by reference for all purposes as if expressly set forth.

### FIELD

The present technology relates to computer graphics, and more particularly to techniques for encoding and decoding (compressing and decompressing) polygon representations. Still more particularly, the technology herein relates to implicit topology encoding schemes which don't require storage of literal indices for reused vertices of polygons.

### BACKGROUND

Ray tracing is a method of graphics rendering that simulates the physical behavior of light. It can add unmatched beauty and realism to renders and fits readily into preexisting development pipelines. In the late 1960's, Arthur Appel computer-generate shaded pictures using ray tracing. Appel, “Some techniques for shading machine renderings of solids”. Proceedings of the Apr. 30-May 2, 1968, spring joint computer conference on—AFIPS '68 (Spring) pp. 37-45. doi: 10.1145/1468075.1468082. S2CID 207171023. Some years later, Turner Whitted showed recursive ray tracing for mirror reflection and for refraction through translucent objects. Whitted, “An Improved Illumination Model for Shaded Display. Proceedings of the 6th annual conference on Computer graphics and interactive techniques” (1979). Later, Hollywood began using ray tracing to produce amazing film animation and special effects. See e.g., Christensen et al, “Ray Tracing for the Movie ‘Cars’”, Pixar Animation Studios, 2006 IEEE Symposium on Interactive Ray Tracing, Salt Lake City, UT, USA, 2006, pp. 1-6, doi: 10.1109/RT.2006.280208. NVIDIA has more recently developed hardware that can perform ray and path tracing in real time (see e.g., developer.nvidia.com/rtx/ray-tracing), realizing the dream of producing real time ray and path tracing effects using inexpensive consumer hardware.

Ray and path tracing is based on determining intersections between light rays and computer-represented objects. Computer graphics systems often represent virtual three-dimensional objects as polygons such as triangles. As the FIG. 1 example shows (developer.nvidia.com/blog/using-turing-mesh-shaders-nvidia-asteroids-demo/), polygon meshes can be used to flexibly define many different kinds of objects. Computer graphics hardware has been designed to process such polygons very efficiently, and information representing each polygon can be specified succinctly.

High school geometry taught us that triangles are defined by three points or “vertices” (the plural of “vertex”). Typically in computer graphics systems, a data structure specifies the triangles (or other polygons) making up a scene by specifying the location in 3D space of each vertex of each triangle, for example:

$$\begin{matrix}Triangle ID = 0496 : {X}_{1} {Y}_{1} {Z}_{1} , {X}_{2} {Y}_{2} {Z}_{2} , {X}_{3} {Y}_{3} {Z}_{3} \\ Triangle ID = 0497 : {X}_{4} {Y}_{4} {Z}_{4} , {X}_{5} {Y}_{5} {Z}_{5} , {X}_{6} {Y}_{6} {Z}_{6}\end{matrix}$$

and so on.

Each triangle can thus be specified by 10 values: its identifier, 3 numbers specifying the location of its first vertex in three-dimensional space, 3 more numbers specifying the location of its second vertex in three-dimensional space, and 3 more numbers specifying the location of its third vertex in three-dimensional space. This may not seem like a lot of information, and in earlier days of computer graphics when polygon counts and spatial resolution was capped by hardware processing limitations, the amount of such information was manageable.

But modern game engines and rendering frameworks are becoming increasingly capable of handling highly complex and irregular geometries. As FIG. 1 illustrates, increasing the number of triangles paves the way for more interesting, realistic and complex object representations—enhancing the user experience and increasing the usefulness of visualizations for medical imaging, scientific research, educational, and many other purposes.

While new software rasterization paths and primitives have been developed specifically for these dense and irregular geometries, raytracing this content has typically been achieved by utilizing legacy software paths and data structures. With an order-of-magnitude increase in geometric complexity (and a corresponding increase in the number of polygons per scene), the design choices made in prior raytracing architectures change and necessitate modifications to achieve optimal performance while also easing developer adoption.

To alleviate storage requirements as scenes became more complex and the number of polygons increased accordingly, NVIDIA developed a prior geometry compression approach described e.g., in U.S. Pat. No. 10,866,990 that compressed geometric data for storage in a lossless compression format. The apparatus included decompression hardware circuitry within a graphics processing unit configured to perform ray-tracing. Example specifications of triangle blocks encoded using such prior techniques include:

• Base vertex (used as vertex 0) [3x 32 bits]
• + Logical delta encoded vertices:

delta_mask.x = ~(((1 << precision.x) − 1) << shift);
vertex.x = (float) (base.x & delta_mask.x) | (delta.x << shift);

• Base triangle ID (used for triangle 0)
• + Logical delta encoded triangle IDs:

delta_mask.id = ~((1 << precision.id) − 1);
triangle.id = (float) (base.id & delta_mask.id) | delta.id;

```
• Per triangle:
  • Alpha + Force-no-cull bits
  • 3x 4-bit vertex indices (reference up to 16 verts)
```

• Except first tri implicitly uses {0, 1, 2}

• Header:
• Mode field (3 bits)

• Allows for motion, VMs, DMM, LSS, etc.

```
  • Number of triangles (up to 16)
  • 5-bit Precision for X, Y, Z, and IDs
  • 5-bit Shift (common for X, Y, and Z)
```

While the above has been highly successful and remains exceedingly useful for unquantized full-precision floating point triangle and other input data, further triangle geometry compression is now needed since the raw increase in geometric complexity requires both a greater memory footprint to store the corresponding triangle geometry and the ability to process triangles at higher throughput rates.

To further increase memory throughout, previously introduced features such as Displaced Micro-Meshes (see e.g., US2023008179; developer.nvidia.com/rtx/ray-tracing/micro-mesh) were developed to tackle memory footprint issues. Displaced Micro-Meshes are very helpful but are best suited to regular geometry and require specific content authoring. Tailoring raytracing hardware to be capable of handling highly complex unstructured and irregular triangle meshes would increase generalized performance and increase the likelihood of raytracing adoption by developers.

More specifically, with the advent of systems providing level-of-detail occlusion culling of highly quantized vertices in object rendering, developers now want to be able to model their scenes with vast numbers (e.g., millions and millions) of polygons. Real time raytracing typically relies on acceleration data structures (AS) defining Bounding Volume Hierarchies (BVHs)—basically large data tree structures or graphs that support ray intersection-based culling. Attempts to raytrace such increased geometric detail results in an order of magnitude increase in time required for a Bounding Volume Hierarchy (BVH) builder to construct raytracing acceleration structures. Often, such ASes are created on the fly, allowing for dynamic changes to the scene. Build time performance therefore becomes a bottleneck. The Acceleration Structure (AS) construction is now the primary performance limiting factor for these new raytracing workloads.

Additionally, as content adopts highly quantized vertex style compression (where we can find vertices using say just 16 bits instead of say 32), there is growing opportunity for more compression options, both for triangle vertex values and topologies.

### BRIEF DESCRIPTION OF THE DRAWINGS

FIG. 1 shows examples of triangle mesh visualizations for different numbers of triangles.

FIG. 2A shows an example builder and rendering system including a raytracer.

FIG. 2B shows an example process performed by the builder.

FIGS. 3-6, 7A, 7B show example a strip based implicit topology features.

FIG. 8 shows an example strip based token topology.

FIG. 9 shows example potential next triangles in a strip.

FIGS. 9A, 9B, 9C show example turn back decoding.

FIG. 10 shows example start token variants.

FIGS. 10A-10Z, 11A-11F are together a flip chart animation showing example encoding and/or decoding of a triangle mesh topology. To view this flip chart animation, please set your viewing device to exactly match the size of the drawings, and then repeatedly depress your “page down” or similar key or control.

FIGS. 12, 12A show example toplogy decoding.

FIGS. 13-16 show example toy encoding.

FIGS. 17A-17F show an additional topology example.

FIGS. 18A, 18B show example vertex compression improvements.

FIG. 19 shows an example per-vertex-component shift.

FIG. 20—shows example vertex base shortening e.g., for quantized vertex data.

FIG. 21 shows an additional base vertex shortening example.

FIG. 22 shows an example arrangement for supporting more triangles per block.

FIGS. 23-26, 27 together show an example highly compressed triangle block.

FIG. 26A shows compression ratio differences between different formats.

FIG. 26B shows example segmentation.

FIGS. 28-30 together show an example compressed treelet (“complet”) data representation.

FIG. 31 shows an example raytracer hardware stack entry.

FIG. 32 shows another example of a real time ray tracing graphics system.

FIG. 33 shows an example ray tracing pipeline.

FIG. 34 shows example ray tracing intersection testing.

FIG. 34A shows example ray tracing processing.

FIG. 35 shows an example TTU hardware block diagram.

FIG. 36 shows a more detailed example TTU block diagram.

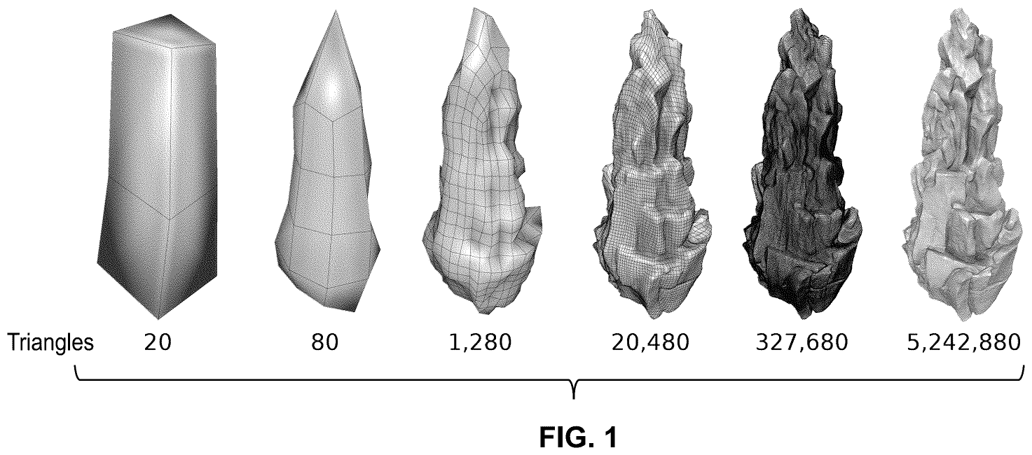

### DETAILED DESCRIPTION OF NON-LIMITING EMBODIMENTS

This technology improves upon existing triangle encoding/compression by providing a new, highly compressed triangle block format enabling 4X more triangles per cacheline-sized block with compression options to better achieve that. Such encoding/compression options include for example: implicit triangle identifiers (versus spending a number of bits per triangle previously), constant alpha and force-no-cull bits (versus spending a number of bits per triangle previously), arithmetic vertex compression with multi-component shifts and base vertex shortening, a strip topology encoding with implicit indexing, and improvements to motion support (e.g., using only half the indices required previously in one embodiment). Example embodiments can thus achieve significantly increased compression such as less than 5B per triangle (a more than 2× decrease as compared to some previous techniques) with single-block formats.

This mechanism has new compression options, as listed above. A Highly Compressed Triangle Block (“HCTB”) builds upon the existing Compressed Triangle Blocks (“CTB”) that go back to prior generations of NVIDIA GPUs but adds/provides:

Alternative vertex compression/encoding including:
a. Per-component shifts
b. Unsigned arithmetic deltas
c. Base vertex shortening

Optional topology encodings, including:
a. 32-vertex explicit indexing
b. Implicit triangle strip indexing with explicit indices for existing vertices
   i. Including left, right, start tokens, turn back, and degenerate tokens
   ii. Including rotation.

Interconnected triangles are often specified by the developer as a grouped geometry commonly called a ‘mesh’ that can vary from a few to millions of triangles connected in a network, but a new term called a ‘cluster’ has entered the lexicon of geometry which refers to a relatively narrow range of interconnected triangle counts such as 128 or 256 triangle cluster, of which a much larger mesh may be comprised. In some contexts, a cluster refers to a small grouping of up to a certain number (e.g. 128) triangles, also sometimes called a “meshlet.” Such clusters can for example be hierarchically organized into a directed acyclic graph (DAG) for Level of Detail (LOD) management. At runtime, the GPU can determine which clusters to render based on visibility and detail requirements. Such a cluster-based approach allows efficient rendering by culling and streaming only needed geometry in small chunks, enabling high detail with minimal performance impact. See e.g., concurrently-filed application Ser. No. 18/990,071 [ref. 6610-179].

The HCTB provides many additional new features and advantages including:
Increased (e.g., up to 64 or more in one embodiment) triangles per block
Increased (e.g., up to 64 or more) vertices per block (more triangles need more vertices)
Option to use implicit triangle identifiers (IDs) (Primary use is an index into a buffer->unsorted triangles have sequential IDs; can store a base and add implicit offsets e.g., tri 1=base+1, tri 2=base+2, etc. for each additional triangle instead of storing additional explicit triangle IDs)
Option to make all alpha and force-no-cull (“FNC”) bits uniform across all triangles (since Alpha+FNC is often common across a block, it is possible to store them only once)
Option to enable/disable opacity micromaps/visibility mask fields (such data has a large overhead if used, so when not used the space for storing the mask fields need not be allocated)
Variable length compression, that preserves the clusters that were optimized for a target number of triangles/vertices.
Allow reduced memory footprint and bandwidth cost when building clusters
   Reasonably good format for on disk compression use
   Establish vertex compression, so assets can be shared with desired quality across industry.
   Flexible and efficient transcode that allows implementations to consume the data on current and future hardware.
   Ideally reduced memory estimates for the footprint of transcoded clusters.
   API that is forward compatible to future formats.

The present disclosure begins by presenting a high level system block diagram. It then explains topology encoding techniques (including implicit triangle strip indexing) that reduce the number of vertices of a triangle mesh that need to be stored. The disclosure then presents new vertex compression techniques that reduce the size of stored vertex data. The disclosure then presents additional memory-saving techniques and associated data structures for triangle blocks and acceleration data structure nodes. The disclosure also discloses a hardware-based tree traversal unit (TTU) structured to efficiently decode and process such geometry data.

### High Level System Block Diagram

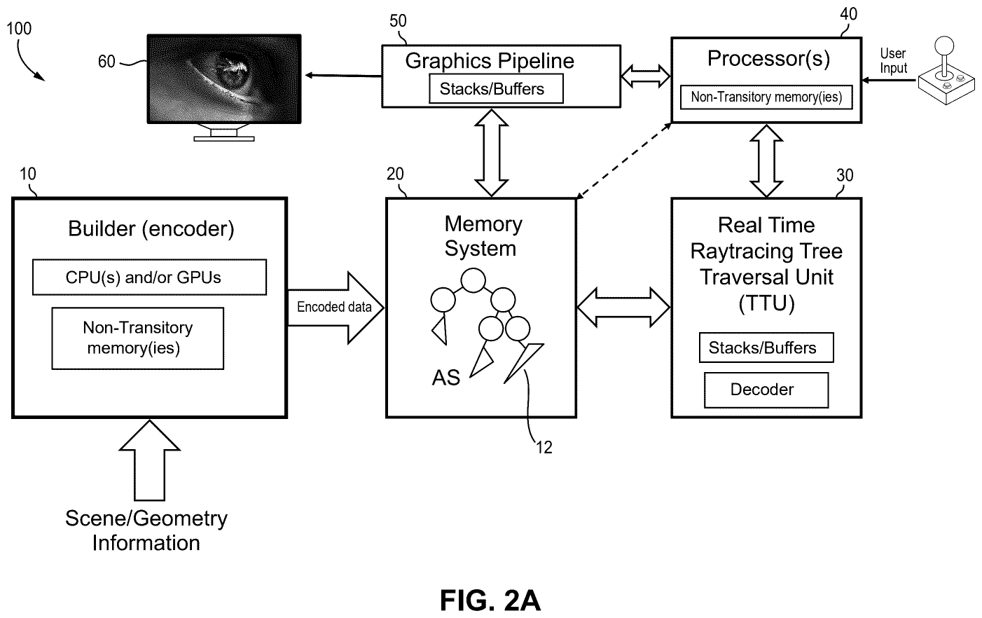

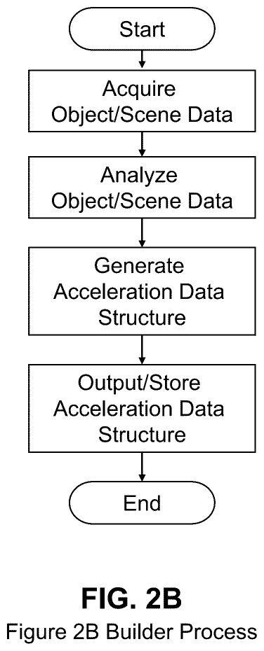

FIG. 2A shows an example high level real time interactive graphics system 100 for generating images using three dimensional (3D) data of a scene or object(s) including the acceleration data structure constructed as described above. In the example shown, system 100 comprises a builder 10, a memory system 20, ray tracing hardware 30, a processor(s) 40, a graphics pipeline 50, and a display 60.

The builder 10 can comprise one or more CPUs and/or GPUs executing instructions stored in non-transitory memory, and is configured to construct an acceleration structure 12 based on an example sequence of operations shown in FIG. 2B. The builder 10 can be non-colocated with the reset of system 10, or it can be colocated with the rest of system 10, and in some embodiments may comprise at least in part the same processors 40 that system 10 uses for other purposes (e.g., where a driver running on the processor 40 dynamically modifies portions of the AS between frames to create new objects or modify existing objects).

The builder typically receives input data defining triangle clusters with per triangle data of 3 vertices with 3 components each. The triangles typically have identifiers that nominally index into a user supplied triangle buffer (the data may reference into a vertex buffer to avoid replication). Each vertex component is usually FP32 (but DirectX Raytracing or DXR allows other formats like FP16) and typically includes an alpha bit and Force-no-cull bit (per-triangle FNC not exposed in DXR). Typical games have unquantized vertices and use the full FP32 range and so may not always achieve substantial compression ratio decreases using the present technological improvements without further quantization processing. Similarly, other applications such as medical image scanners, sensors for heads up displays, etc. may provide data in other kinds of formats that may need further processing to provide triangle clusters the builder 10 can work from. However, some formats now provide highly quantized vertex data that is often significantly less than the full FP32 (common exponents and reduced mantissa use). This kind of highly quantized data will realize substantial compression ratio improvements with a builder 10 that uses the technology herein to form compressed triangle blocks.

The builder 10 takes this triangle cluster information and uses it to construct triangle blocks and a BVH over the triangle blocks, i.e., a specialized data structure called an “acceleration structure” or AS. This AS 12 may be stored on disk storage and/or cloud storage, and is eventually stored in memory system 20 connected to the raytracing hardware 30.

In one embodiment, the raytracing hardware 30 reads the AS 12 (both graph nodes called complets or “compressed treelets,” and triangle blocks) from memory 20 in cacheline sized chunks and processes them to provide ray-object intersection results to processor(s) 40 (see below). The size of the cacheline (128 bytes in one embodiment, but other implementations can have other sizes) determines the amount of information that can be stored in a triangle block and thus compression ratios.

The system 10 uses such raytracing results to provide visualization (e.g., reflection, refraction, shadows, global illumination) on display 60 (e.g., reflection mapping of the eye in this example), e.g., typically in combination with additional visualization results provided by shader and rasterization algorithms operable on processor(s) 40 and/or graphics pipeline(s) 50, in response to interactive inputs provided by a user(s). Other embodiments could use raytracing and/or pathtracing to create scenes and other visualizations without involving rasterization. Still other embodiments can rasterize based on the AS to create scenes and other visualizations without involving the raytracer. The Triangle Compression and Decompression techniques described herein are general purpose and are not limited to raytracing, path tracing, rasterization, or any other particular image or other processing after decompression/decoding.

### Topology Compression

This section details new topology compression options for triangle blocks. In computer graphics, “canonical” geometric information is typically thought of as defining the locations of points such as vertices, whereas topological information records the structure of a scene such as how points are aggregated to form polygons, how polygons form objects, and how objects form scenes. See e.g., Newman et al, Principles of Interactive Computer Graphics at 300 et seq., McGraw-Hill (2d. Ed. 1979).

The evaluation of topology compression is influenced by a few considerations including Runtime usage:
Topology information may be accessed in bulk
Rasterization of clusters or subsets thereof
Transcoding cluster for ray tracing
Random access individual triangles (Accessing information for shading from visibility buffer/ray tracing hits)
Optimization for bulk decode/better compression (users can handle random access as it often also involves attribute fetches. Users decompress to simple triangle list representations at runtime if this is needed).
Ability to estimate the vertex re-use, which often influences the transcoded memory of user data into implementation-dependent representations.
Indexing of vertex attributes: Whilst ray tracing only requires positional information, triangle indices are often used to also access other vertex attributes for shading (normals, texture coordinates . . . ).
Re-use of topology: This is something that the cluster template mechanism allows developers to express already (tessellation patterns, instancing same model many times with different animation)

Example embodiments are based on a token representation for generalized triangle strips.

Briefly, one embodiment herein adds explicit topology with 5-bit vertex indices. An example embodiment also adds a 4-bit implicit token-based strip topology mode to support up to 64 triangles+64 vertices when in strip topology mode. Using such implicit token-based technology, the strip of the triangle mesh is purposefully constructed of triangles that share common vertices to reduce the total number of explicit vertex locations that need to be stored.

### Explicit Formats

Legacy formats use explicit indexing where each triangle (after the first) specifies using an N-bit index which 3 vertices it uses. The first triangle is always assumed to use vertices {0, 1, 2}. New in one particular embodiment is the ability to specify a 5-bit index to explicitly index up to 32 vertices. 5-bit index widths are useful when blocks have >16 but less than 32 vertices, 4-bit widths is useful when blocks have 16 or fewer vertices, and 6-bits is also possible but may not be used much in some contexts. For N triangles, the topology encoding cost is either 15*(N−1) or 12*(N−1) depending on whether 4 or 5 bits are used for the indexing.

### Strip Topology

The example embodiment topology compression adds a token-based strip topology mode. In this mode, adjacent triangles in the strip reuse each other's vertices and each triangle has a token that encodes how to create the vertex indices. This strip topology compression (encoding and decoding) can be used for unstructured data-basically, any triangle data input to the builder can be compressed using such embodiments. Meanwhile, quantized vertices can be more compactly compressed using vertex compression, which allows more room for strip topology.

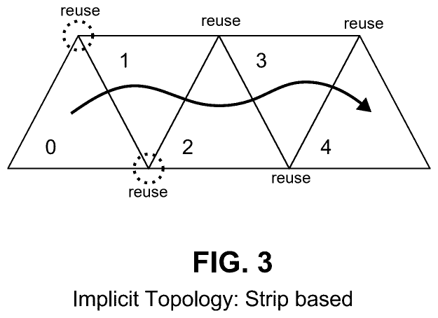

As the FIG. 3 example shows, in a strip, each new (additional) triangle added to the strip reuses two (2) vertices from the previous triangle, either adding an implicit new (third) vertex or reusing an existing explicit vertex. In the example shown, due to this vertex reuse, five triangles (having a total of 15 vertices) can be represented by specifying/storing only 7 unique vertices. This results in a significant memory savings. See e.g., Evans et al, “Optimizing triangle strips for fast rendering,” Proceedings of Seventh Annual IEEE Visualization '96, San Francisco, CA, USA, 1996, pp. 319-326, doi: 10.1109/VISUAL.1996.568125; Vaněček et al, “Comparison of triangle strips algorithms” Computers & Graphics, Volume 31, Issue 1, 2007, Pages 100-118, //doi.org/10.1016/j.cag.2006.10.003. This is true for non-strip topology indexing as well (vertex count is independent of the strip topology, except when dealing with the fully implicit strip topology).

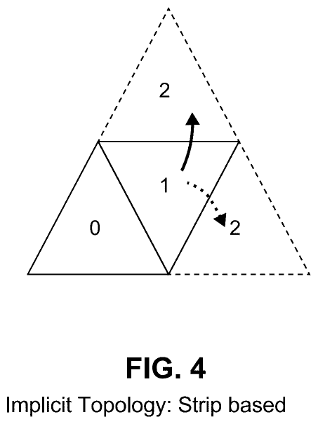

In example embodiments, each new triangle is added to either the left or right (one side or the other side) of a previous triangle. Reusing the edge just used (e.g., the one between triangle 0 and 1) is no longer a strip topology and is not encoded (folding back on the edge just used is not allowed). See FIG. 4.

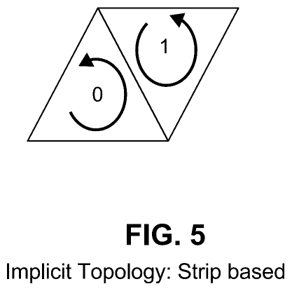

Winding is preserved by flipping the direction of the shared edge. See FIG. 5.

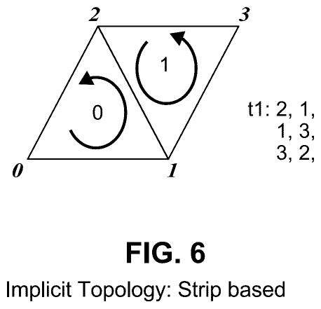

Triangles may be rotated though such that triangle 1 could be specified with vertices at either {2, 1, 3}, {1, 3, 2}, or {3, 2, 1} as shown in FIG. 6. Each of these three variations is still a valid strip, only the barycentric mapping is affected. This rotation is supported by a new token format in example embodiments.

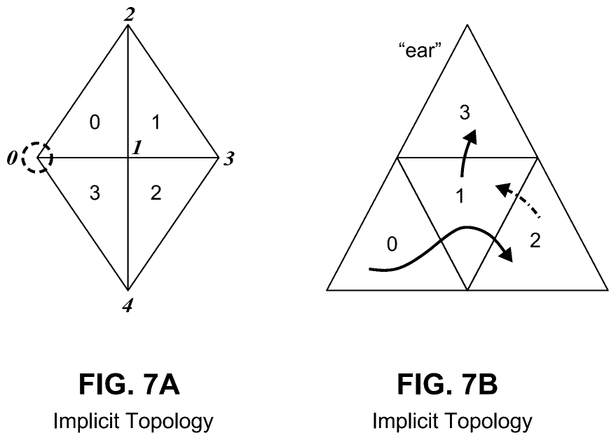

FIG. 7A shows that all vertices of a new triangle added to the strip can be reused—there is not always a new vertex being added (e.g., Triangle 3={4, 1, 0} versus {4, 1, new}).

FIG. 7B shows that meshes can be strips with “ears”, i.e., triangles that extend beyond the strip. A “turn back” signal can allow the “strip” to continue past such an “ear” triangle.

Meshes can be trivially supported with a “turn back” signal that allows a strip to continue past an “ear”. In the example of FIG. 7B, the strip 0, 1, 2, can continue to triangle 3 by adding a “turn back” token after 2 which causes the decoder to move back to use triangle 1 as the base for triangle 3 instead of using triangle 2 as the base.

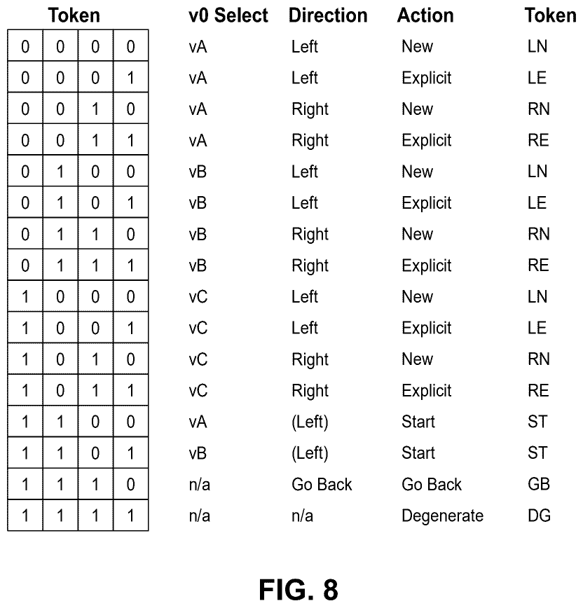

By encoding the various states, an example embodiment can get by with 4-bits encoding 16 states as seen in FIG. 8 and below (the example token encoding bit patterns below are arbitrary and can be changed):

| Token | v0 select | direction | action | token |
|---|---|---|---|---|
| 0000 | vA | Left | New | LN |
| 0001 | vA | Left | Explicit | LE |
| 0010 | vA | Right | New | RN |
| 0011 | vA | Right | Explicit | RE |
| 0100 | vB | Left | New | LN |
| 0101 | vB | Left | Explicit | LE |
| 0110 | vB | Right | New | RN |
| 0111 | vB | Right | Explicit | RE |
| 1000 | vC | Left | New | LN |
| 1001 | vC | Left | Explicit | LE |
| 1010 | vC | Right | New | RN |
| 1011 | vC | Right | Explicit | RE |
| 1100 | vA | (Left) | Start | ST |
| 1101 | vB | (Left) | Start | ST |
| 1110 | n/a | Turn Back | Turn Back | GB |
| 1111 | n/a | n/a | Degenerate | DG |

In the example embodiment shown above, there are:
3 states (2 bits) for Left, Right, and Back
2 states (1 bit) for Implicit New versus Explicit Reuse (if reusing, add 5 bits for the explicit index, can be 4, 5, or 6 bits but constant for the block; alternative: fully implicit format, but with vertex replication)
2 states (1 bit) to indicate which rotation (only supports the “C” rotation)
3 states to start a new strip (use 3, 2, or 0 explicit indices)
1 state for degenerate triangles (used for complet indexing).

The example embodiment combines states rather than bits—16 states==4 bits with the following pattern:
[Left, Right, Back]×2 Rotation×[New, Existing]
+3 Start+1 Degenerate
Start only needs 2 rotations versus full 3.

### Degenerate State

When the complet needs to start or end on an even index in order to adjust an index for one triangle, it may need to occasionally pad the indices in order to bump the indices for successive triangles. In one embodiment, a degenerate token can be used to extend the length of the triangle block to force an even start or end for some triangle range. In example embodiments, even starts are required by the complet format when indexing greater than 32 triangles. A degenerate triangle can be included there because while the decoder will decode it, the ray tracing or rendering hardware will essentially ignore it. Specifically, in example embodiments, such degenerate triangles are used for complet indexing.

As noted above, a specific “degenerate” state can be used to encode a degenerate triangle that uses vertices {0, 0, 0}. Since such a degenerate triangle is a point, it cannot be hit by a ray and would not be tested nor will it define any polygon to shade. Its use in example embodiments is to simplify and save bits in the encoding space in the complet. A degenerate token takes up token space in the block and is included in the triangle count for indexing purposes. A degenerate token is not counted for implicit indexing purposes though.

### New Vertex Indices and Finding Explicit Indices

The above describes a set of compact tokens that represent incremental changes to a triangle strip and instruct a decoder how to reconstruct a triangle strip the encoder received from the builder. As will be appreciated, these token based instructions are supplemented in example embodiments with additional vertex indices that index or point out vertices stored within a vertex buffer. However, as noted above, such indexing or pointing can be explicit or implicit. Implicit vertices can be derived from previous information decoded by the decoder—meaning there is no need to carry, in the encoded data stream, additional information beyond the token. Just to be clear, in all cases the actual vertex information is stored in a vertex buffer. This aspect of the example embodiment's technology relates to information encoded data stream uses to enable the decoder to index or point to the vertex information in the vertex buffer.

By way of analogy, suppose you wanted to find a computer graphics textbook on the shelves of your local college library. The search computer in the library tells you the library call number for your book is T385.N48 1979. This explicit index allows you to go to the shelves and find that specific book. Now suppose your friend tells you that while you are at the shelves trying to locate your book, he would like the book (a second edition) immediately to the right of the book indexed by your call number. This “just to the right” information could be considered an implicit index as opposed to the explicit index. The implicit index is more compact than the explicit index and relies on the explicit index call number you are already using to look up your book on the shelves.

In one embodiment, implicit “new” vertex indices are calculated using a prefix sum counting the tokens with a new action:

$$Next new vertex = 3 + PrefixSum ( New )$$

Explicit indices meanwhile are stored in a separate array that itself has implicit indexing. In one embodiment, the implicit index for the explicit index array is also given by a prefix sum calculation:

$$Next explicit index = 3 * PrefixSum ( Start ) + PrefixSum ( Explicit )$$

In one embodiment, for explicit array index purposes, the first triangle does not count as a Start token. It is an implicit start token, but not an actual start token. The implicit start token is taken into account by the “3+” in the next new vertex calculation.

### Choosing Edges and Rotations

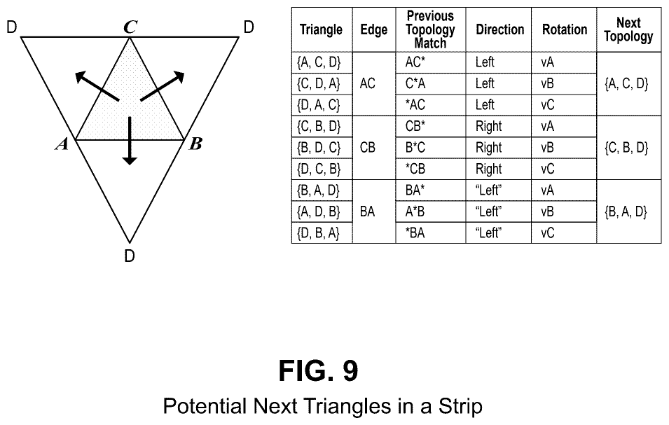

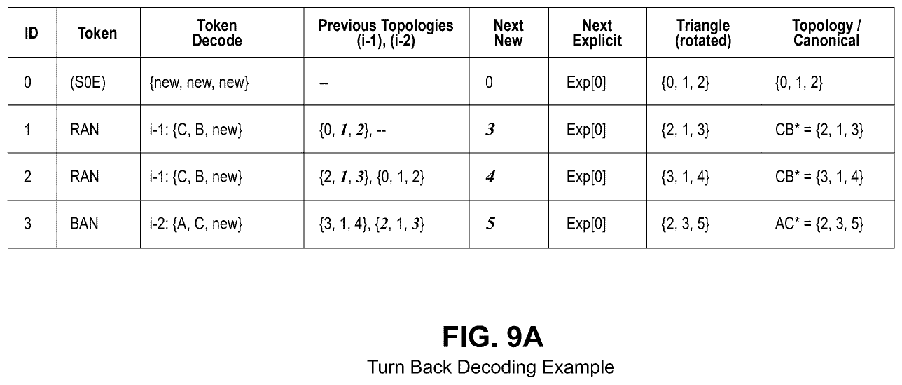

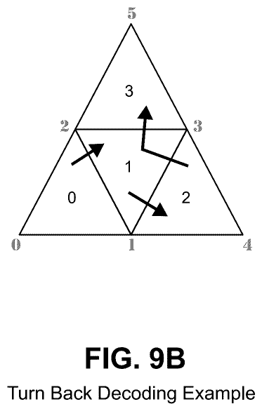

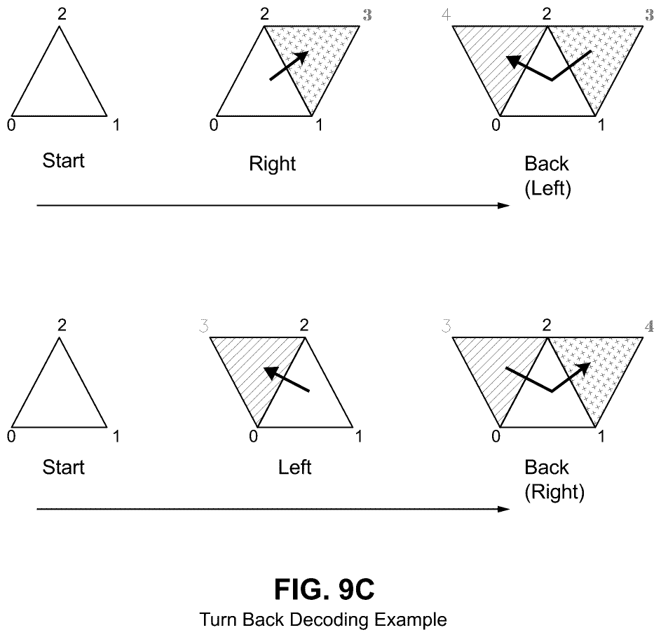

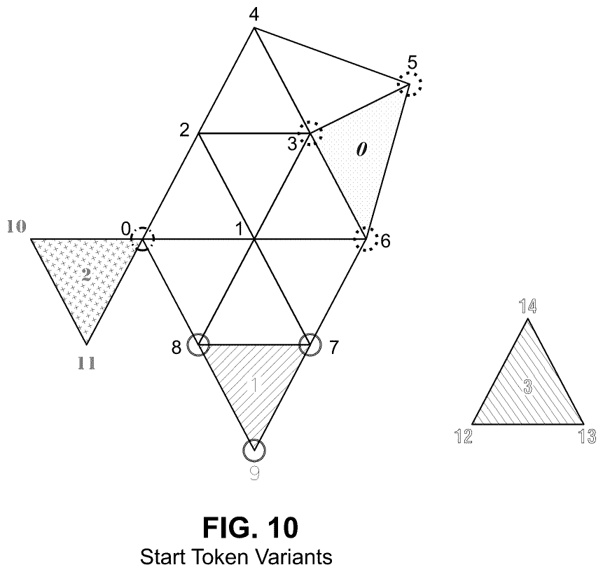

As illustrated in FIG. 9, from a starting triangle {A, B, C} there are three possible new triangles each with 3 rotations to continue the strip. For example, if the AC edge is chosen, there could be an ACD, CDA, or DAC triangle. To facilitate matching when encoding the next triangles, example embodiments may use a single topology triangle that is ACD instead of having to match against any of the equivalent ACD, CDA, or DAC triangles. The table below and in FIG. 9 shows example direction, rotation, and next topology for each of the possible triangles:

| | | Previous | | | |
|---|---|---|---|---|---|
| | | Topology | | | Next |
| Triangle | Edge | Match | Direction | Rotation | Topology |
| (A, C, D) | AC | AC* | Left | vA | (A, C, D) |
| (C, D, A) | AC | C*A | Left | vB | (A, C, D) |
| (D, A, C) | AC | *AC | Left | vC | (A, C, D) |
| (C, B, D) | CB | CB* | Right | vA | (C, B, D) |
| (B, D, C) | CB | B*C | Right | vB | (C, B, D) |
| (D, C, B) | CB | *CB | Right | vC | (C, B, D) |
| (B, A, D) | BA | BA* | “Left” | vA | (B, A, D) |
| (A, D, B) | BA | A*B | “Left” | vB | (B, A, D) |
| (D, B, A) | BA | *BA | “Left” | vC | (B, A, D) |

In an example specific embodiment, those triangles that continue from the BA edge can only occur for a start triangle (because BA is rare, one embodiment does not support it otherwise in order to reduce token bit count). The BA edge use forces the previous Start token to shift to a vB topology rotation instead of the default vA. Rotation for starts only affects the topology matching and not the actual triangle. The vC rotation is not required for Start, as vA and vB are sufficient to cover shifting all edges into a position acceptable for topology use.

### Turn Back Encoding

If a next triangle does not use an edge of the previous triangle, then it would be encoded as a start triangle with 3 explicit indices. However, in example embodiments, if the triangle matches with a triangle one before the previous, then it can add a “turn back” token as well as its own token. The Turn Back token increments the triangle count as well but does not increment implicit indexing. See FIG. 9A, 9B, 9C.

Without “Turn Back”, a simple 4-tri mesh needs a second Start. Turn Back moves decode back one triangle and uses the “other” direction. Example embodiments can impose limits (token effectively ignored if broken) such as:
Only 1 Turn Back allowed in a row (simplifies hardware decode)

Turn Back cannot be the first token in the block (excluding the implicit start for the first triangle).

An alternative implementation without “turn back” would provide an additional, explicit index.

### Start Token Variants

In example embodiments, there are 3 Start Tokens: S3E, S2E, and S0E:
S3E uses 3 explicit tokens in the form {explicit, explicit, explicit}
S2E uses 2 explicit tokens in the form {explicit, explicit, new}
S0E uses no explicit tokens and has the form {new, new, new}

In the use of “explicit” above: the actual index can be either new or existing; example embodiments compare the content of the explicit array index with the “next new” to know which.

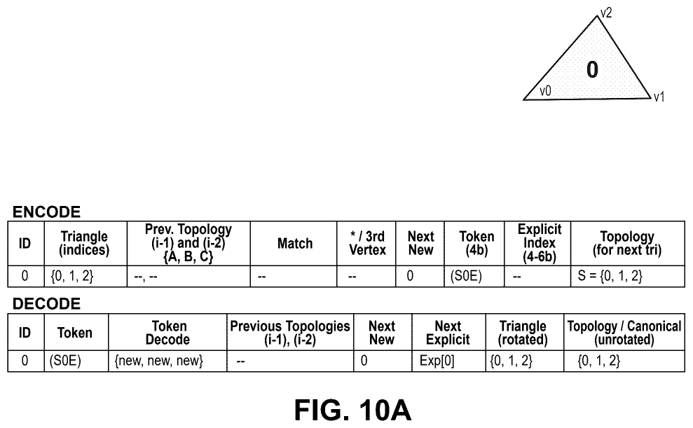

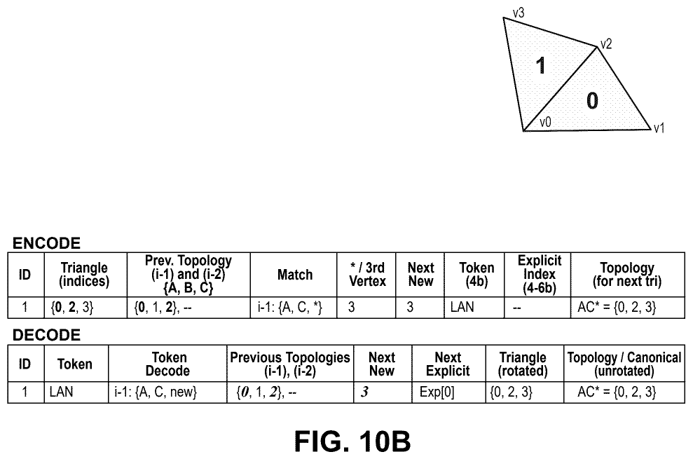

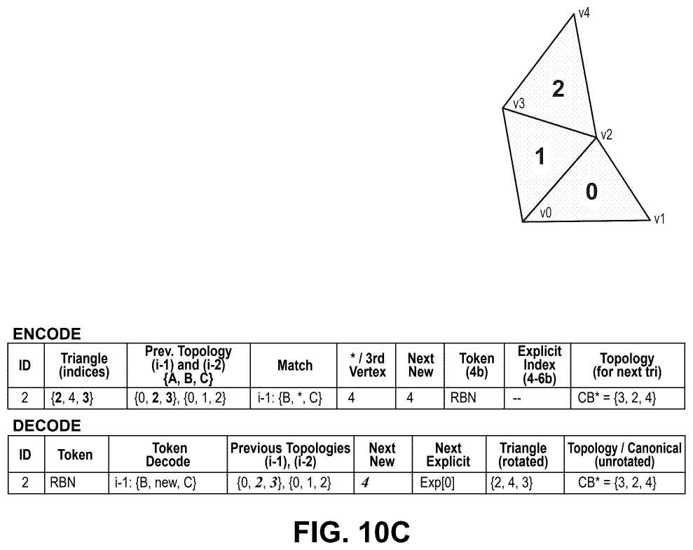

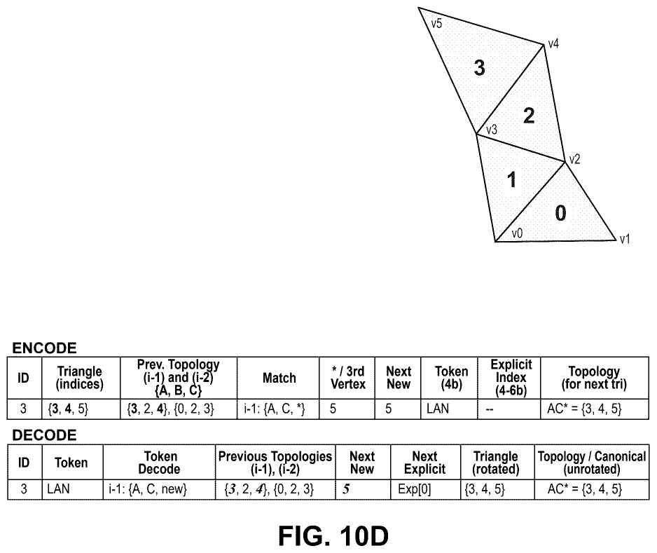

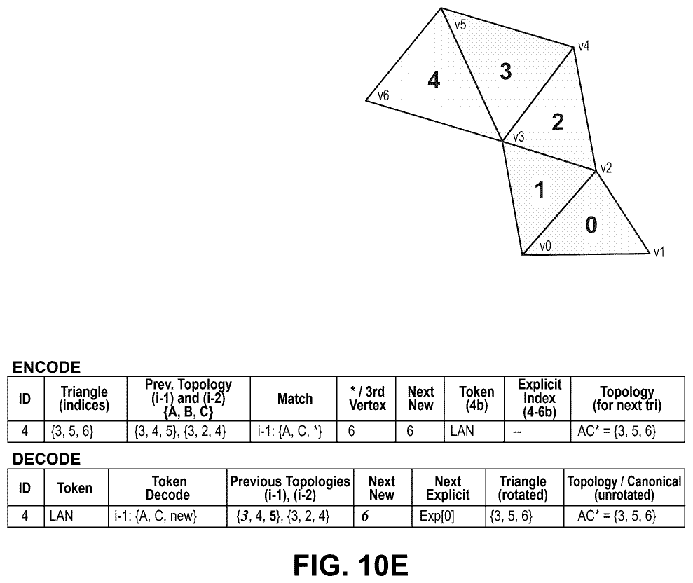

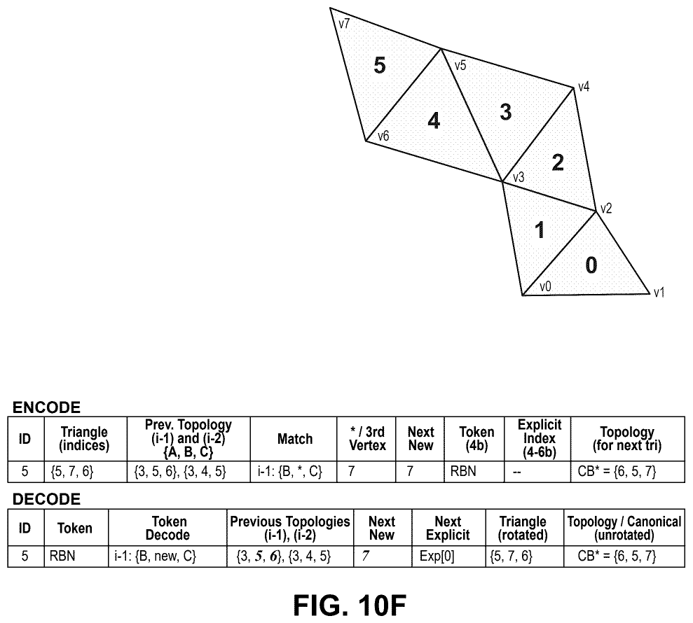

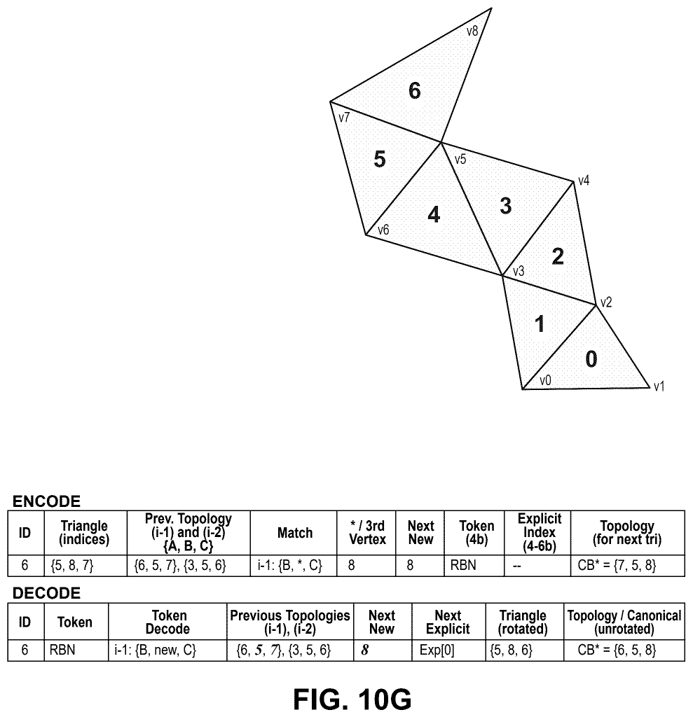

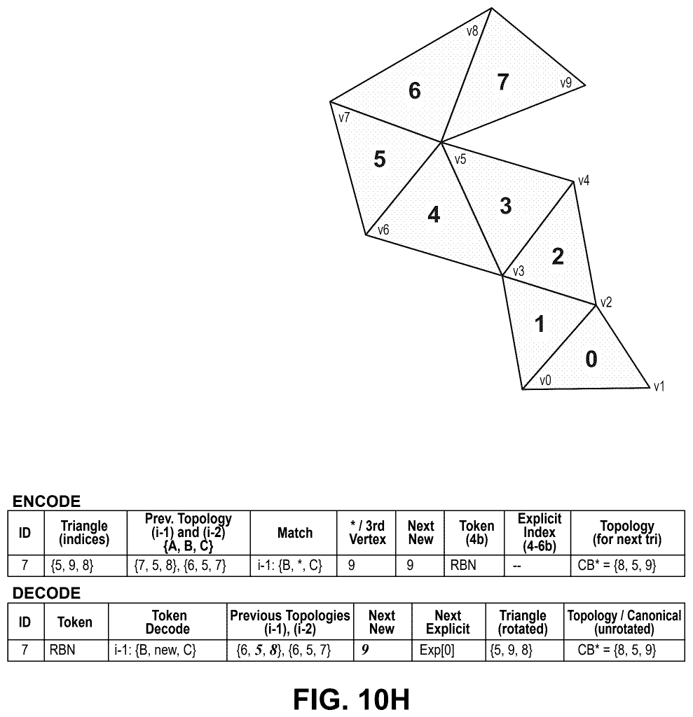

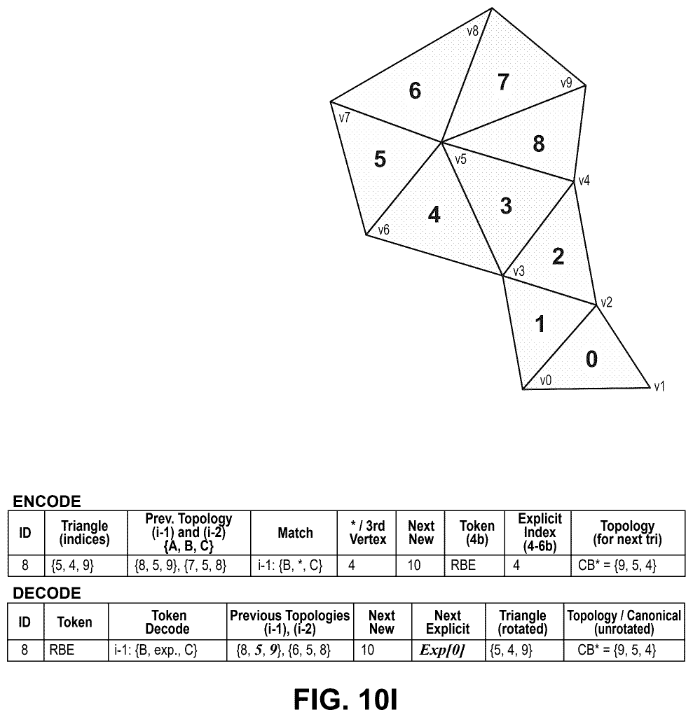

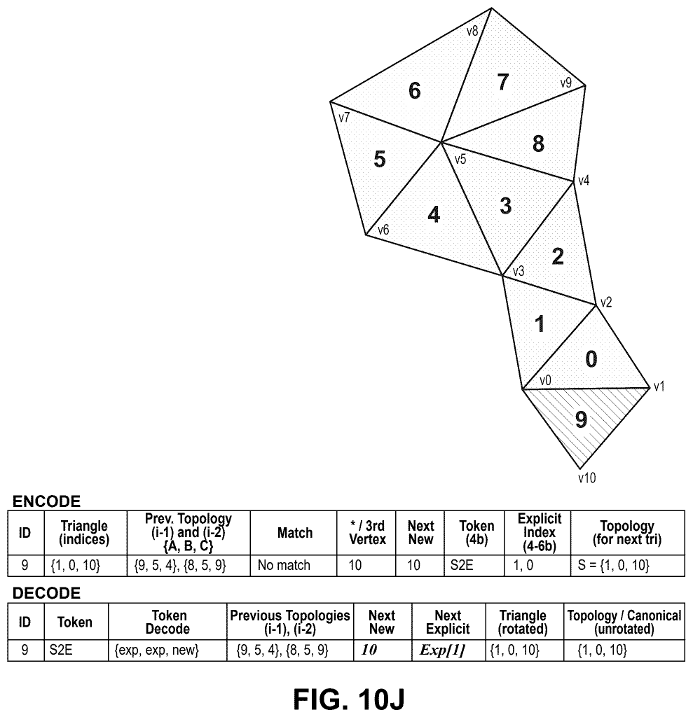

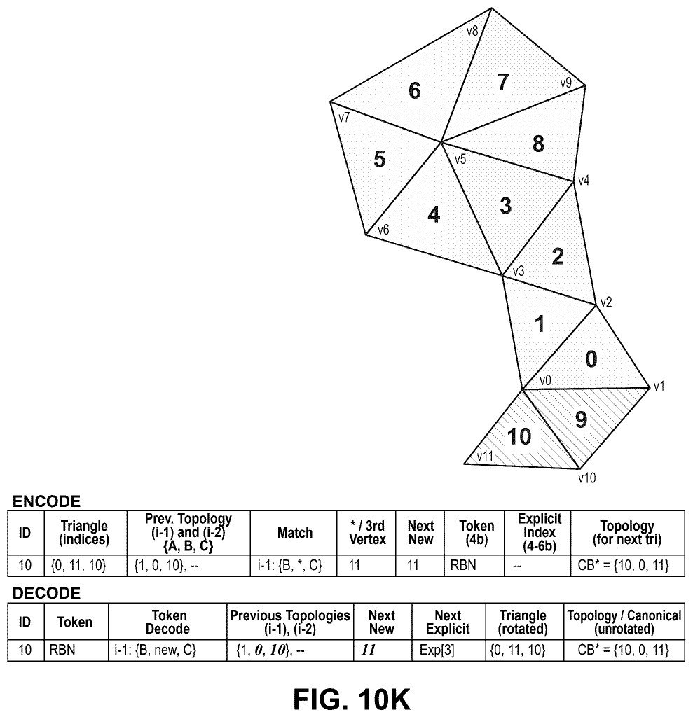

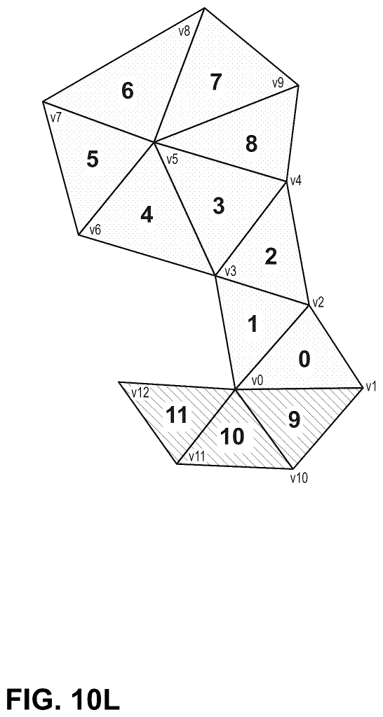

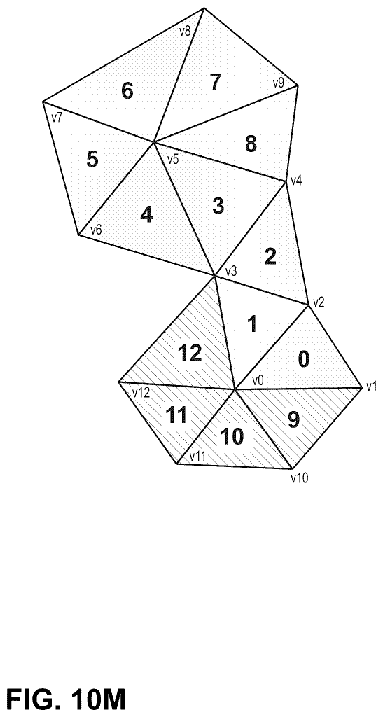

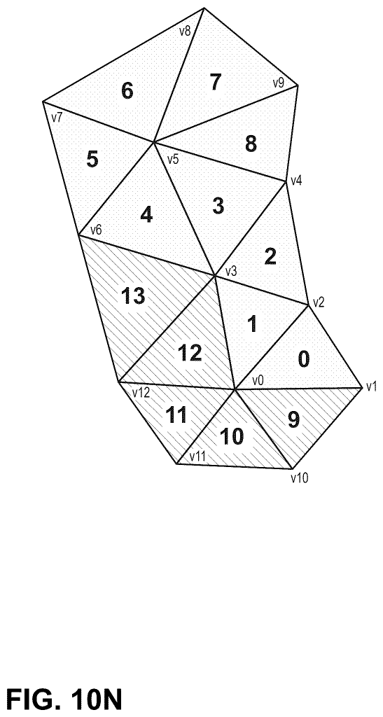

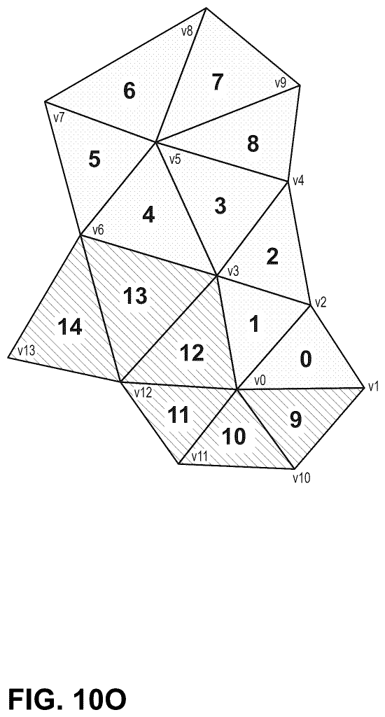

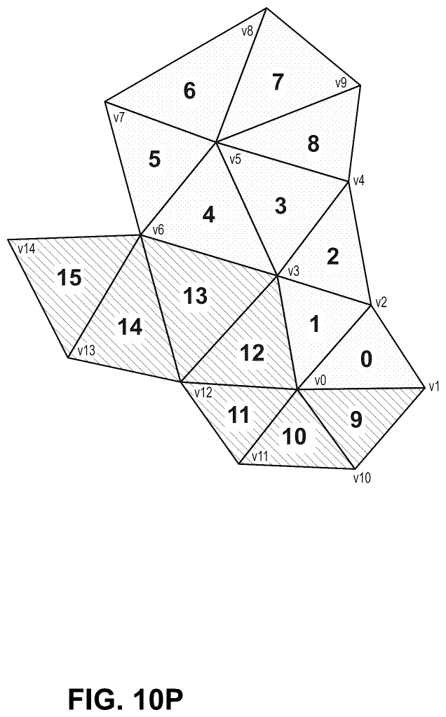

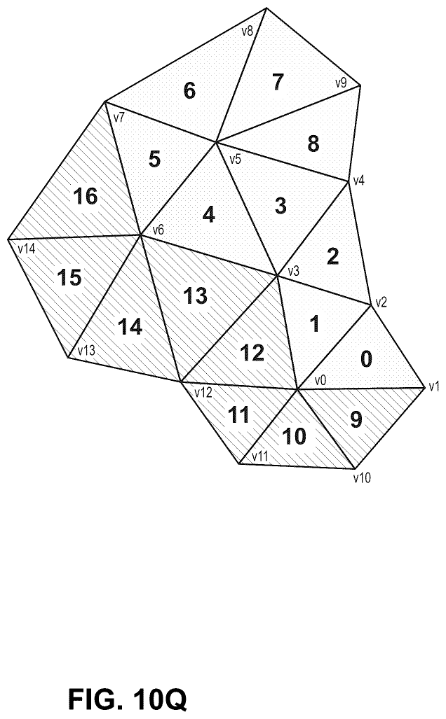

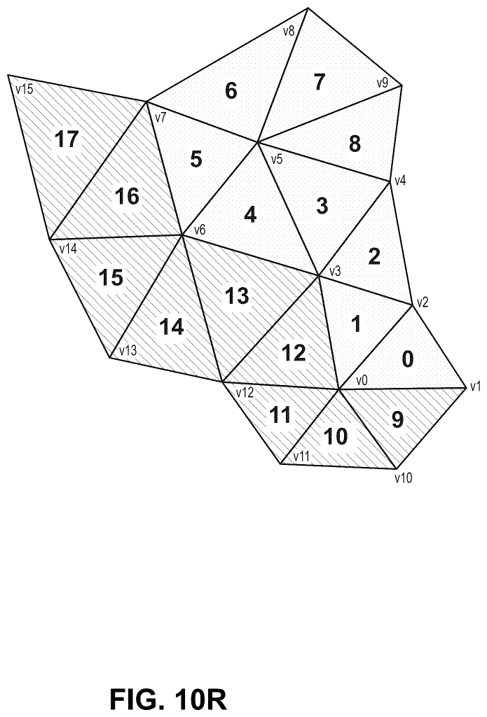

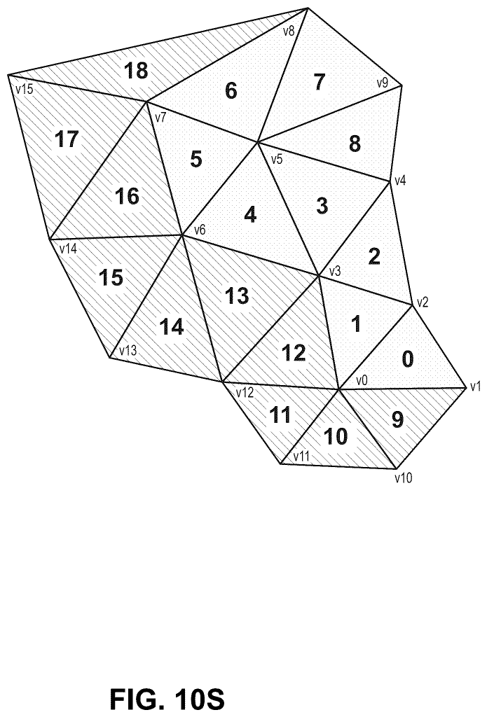

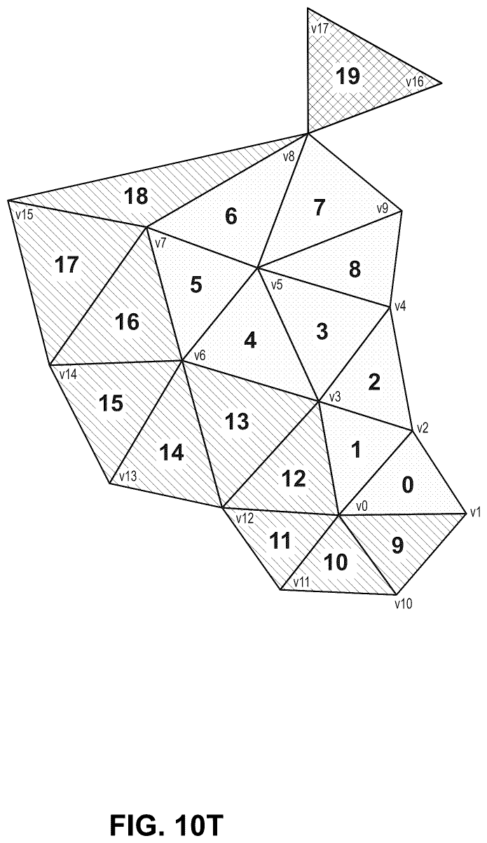

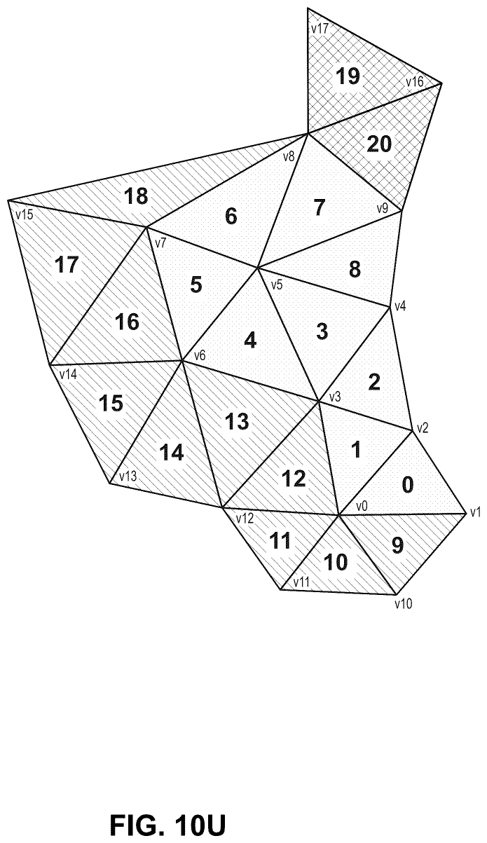

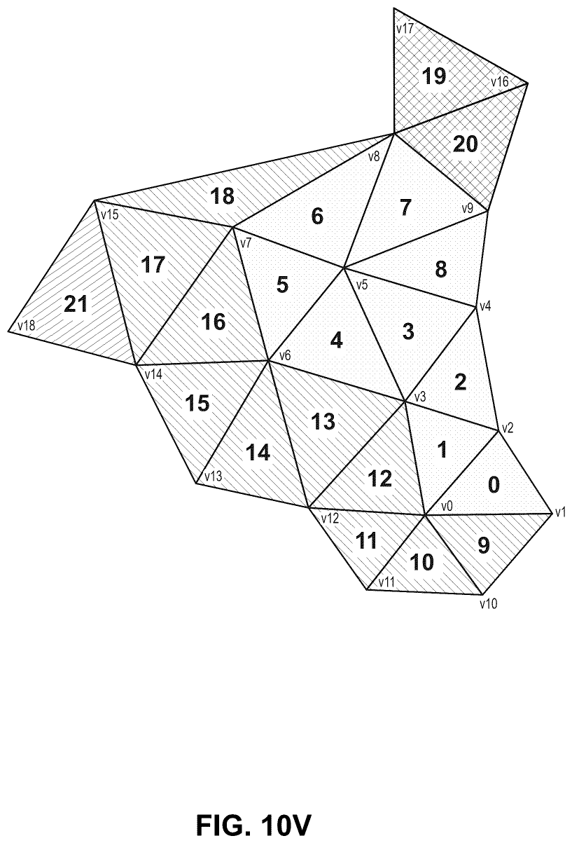

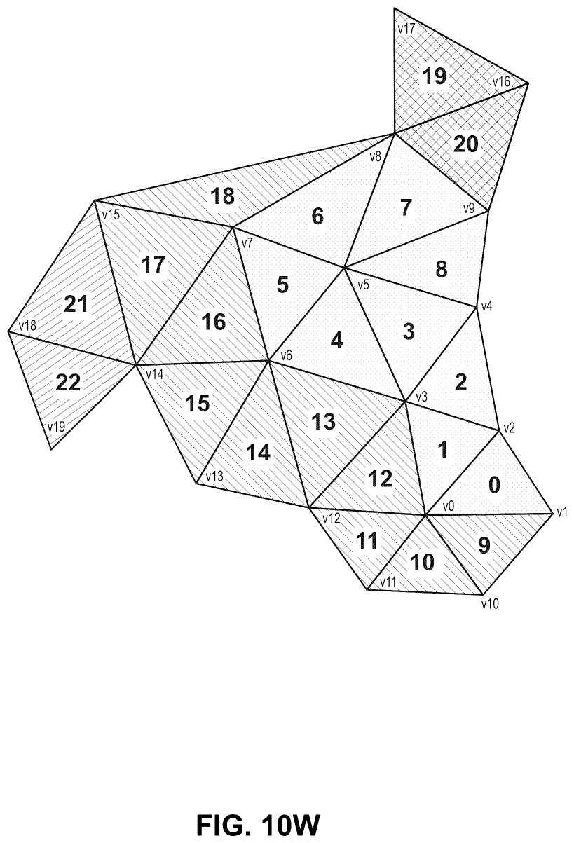

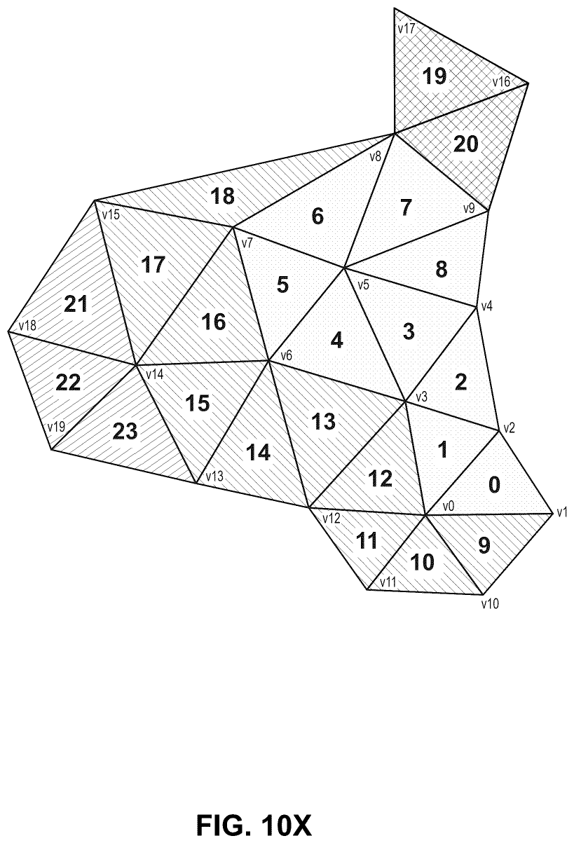

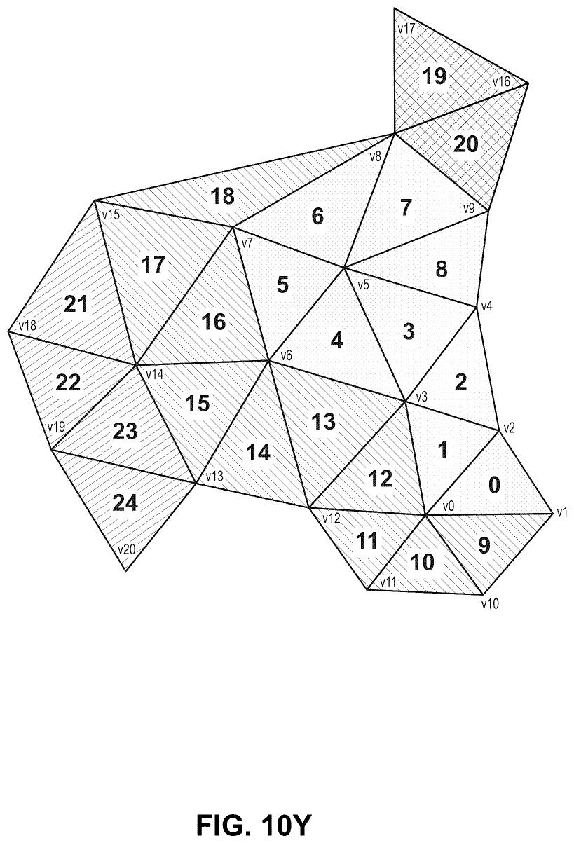

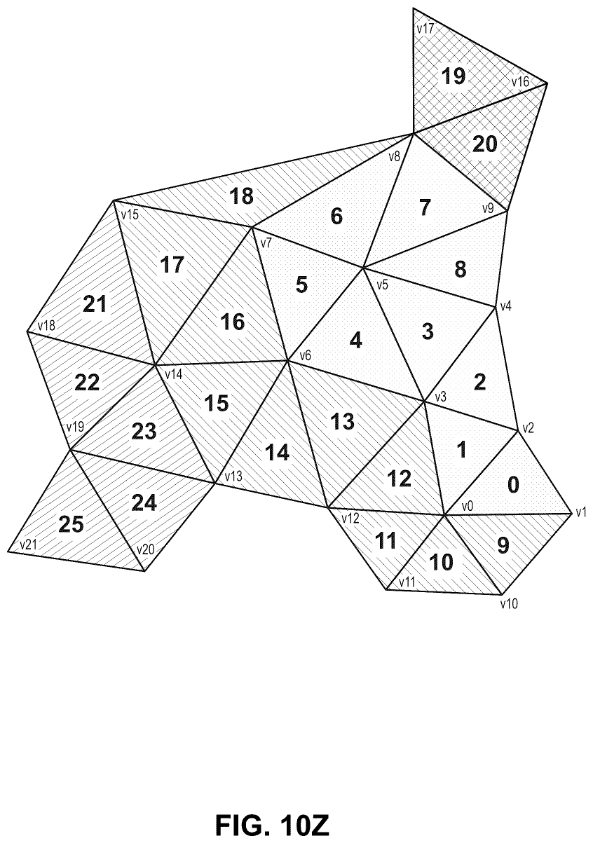

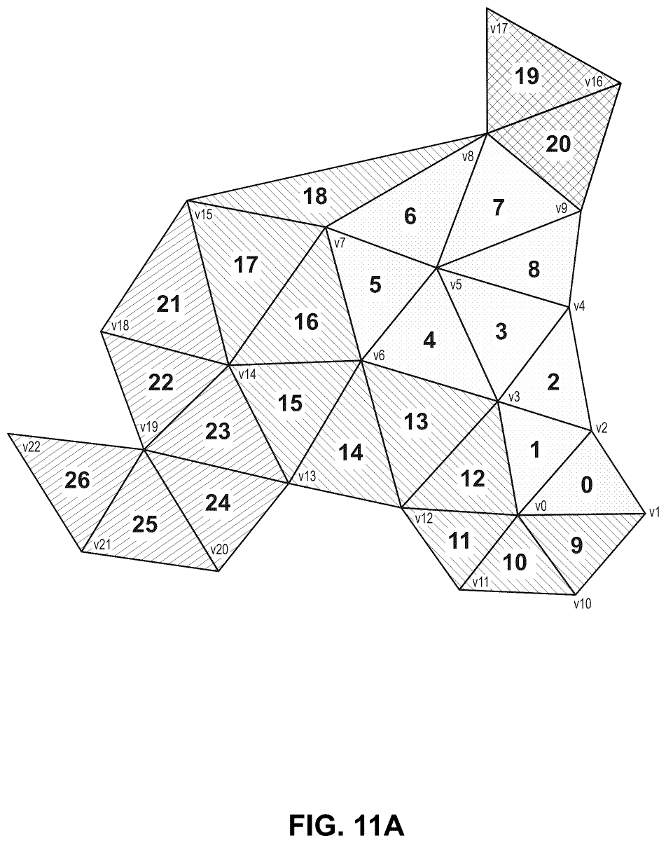

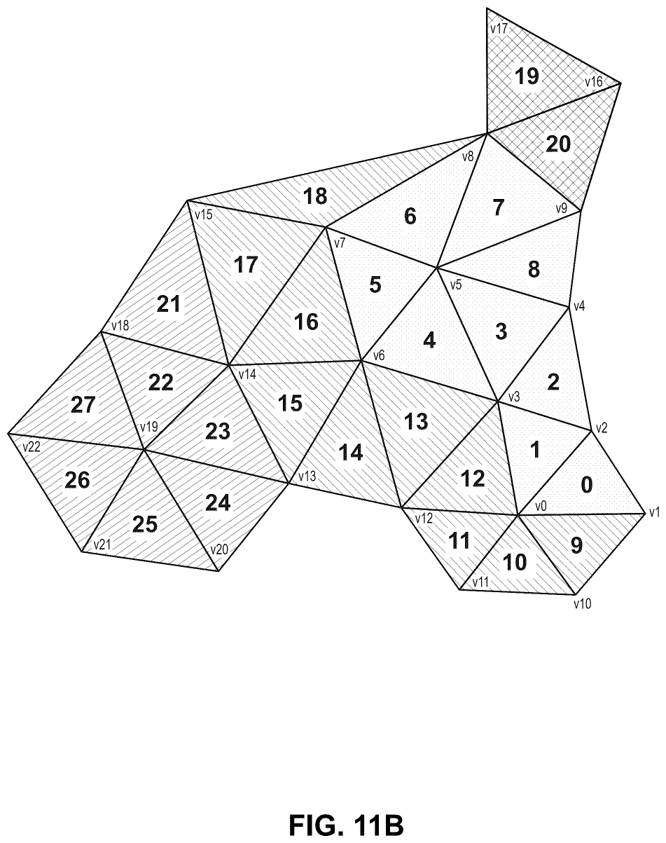

FIG. 10 details—with an example existing 8-triangle mesh-four different example start token scenarios illustrated in different crosshatch styles. In this example:
Triangle 0 uses 3 existing vertices (3, 5, and 6) so will be encoded as S3E. Because S3E is {explicit, explicit, explicit}, the ordering, or rotation, is directly assigned.
Triangle 1 uses 2 existing vertices (7, 8) so might be S2E. If it is either {7, 8, 9} or {8, 7, 9}, then it can be encoded as S2E, otherwise, it should be encoded as S3E. In one embodiment, S2E requires an {explicit, explicit, new} ordering, so the new vertex will be the 3^{rd} vertex. Other orderings would require bits to encode it, and this one is common.
Triangle 2 uses one existing vertex (0) and is either S2E or S3E. It is a candidate for an “SIE” token, but vertex order matters: which one is E? This instance would use additional bits to encode the order. It can be S2E unless it is {10, 11, 0} in which case it would be S3E. {10, 11, 0} has the 1 “existing” vertex in S2E's “new” vertex spot.
Triangle 3 uses no existing vertices and should encode as S0E. There is no reason to use S2E or S3E as they take more bits in this case.

### Example Encoding

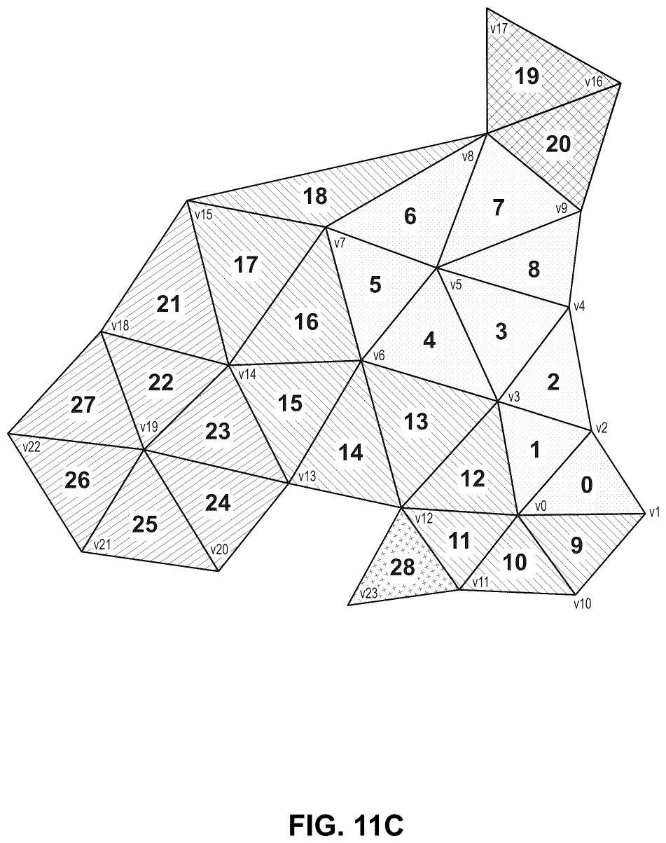

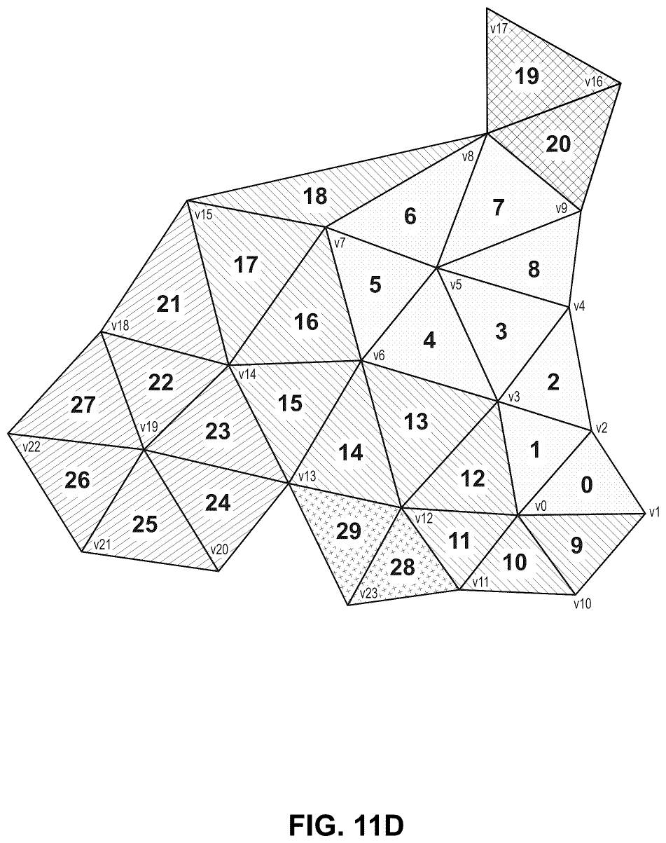

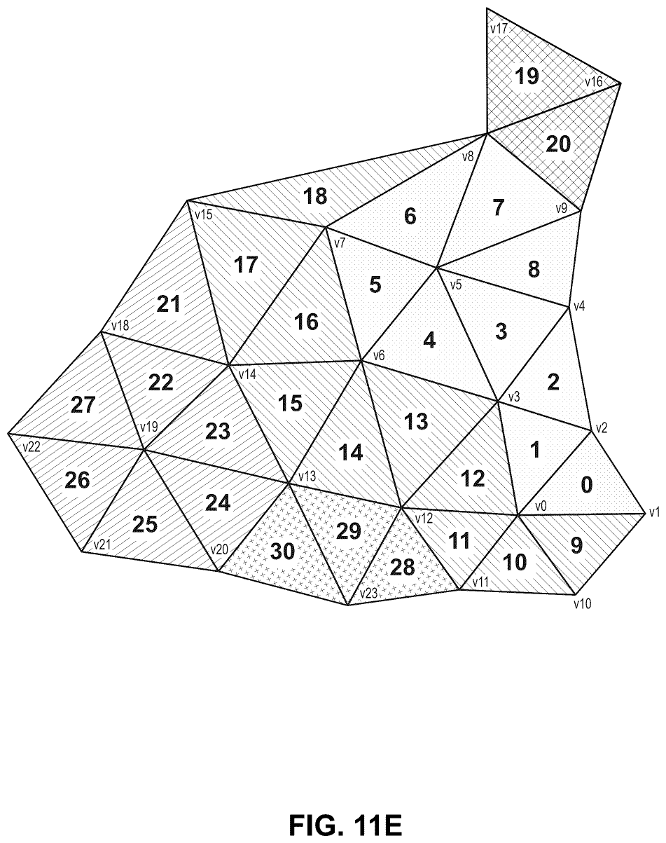

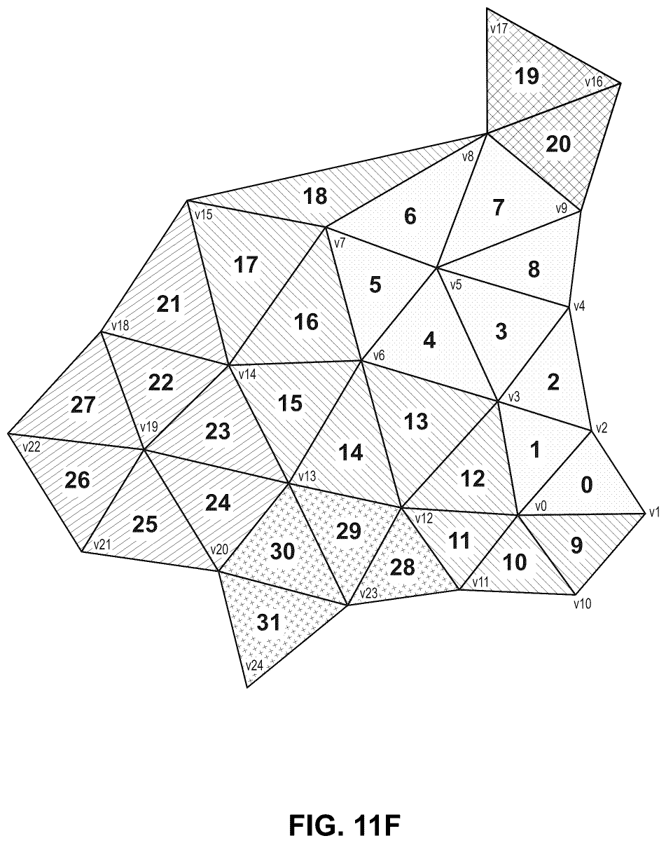

FIGS. 10A-10Z, 11A-11F (flip chart animation) show an example real world mesh encoding example based on the following sequence of encoding steps:

| | | Prev. Topology | | | | | | |
|---|---|---|---|---|---|---|---|---|
| | Triangle | (i-1) and (i-2) | | */3^{rd} | Next | | Explicit | Topology |
| ID | (indices) | {A, B, C} | Match | Vertex | New | Token | Index | (for next tri) |
| 0 | {0, 1, 2} | —, — | — | — | 0 | (S0E) | — | S = {0, 1, 2} |
| 1 | {0, 2, 3} | {0, 1, 2}, — | i-1: {A, C, *} | 3 | 3 | LAN | — | AC* = {0, 2, 3} |
| 2 | {2, 4, 3} | {0, 2, 3}, {0, 1, 2} | i-1: {B, *, C} | 4 | 4 | RBN | — | CB* = {3, 2, 4} |
| 3 | {3, 4, 5} | {3, 2, 4}, {0, 2, 3} | i-1: {A, C, *} | 5 | 5 | LAN | — | AC* = {3, 4, 5} |
| 4 | {3, 5, 6} | {3, 4, 5}, {3, 2, 4} | i-1: {A, C, *} | 6 | 6 | LAN | — | AC* = {3, 5, 6} |
| 5 | {5, 7, 6} | {3, 5, 6}, {3, 4, 5} | i-1: {B, *, C} | 7 | 7 | RBN | — | CB* = {6, 5, 7} |
| 6 | {5, 8, 7} | {6, 5, 7}, {3, 5, 6} | i-1: {B, *, C} | 8 | 8 | RBN | — | CB* = {7, 5, 8} |
| 7 | {5, 9, 8} | {7, 5, 8}, {6, 5, 7} | i-1: {B, *, C} | 9 | 9 | RBN | — | CB* = {8, 5, 9} |
| 8 | {5, 4, 9} | {8, 5, 9}, {7, 5, 8} | i-1: {B, *, C} | 4 | 10 | RBE | 4 | CB* = {9, 5, 4} |
| 9 | {1, 0, 10} | {9, 5, 4}, {8, 5, 9} | No Match | 10 | 10 | S2E | 1, 0 | S = {1, 0, 10} |
| 10 | {0, 11, 10} | {1, 0, 10}, — | i-1: {B, *, C} | 11 | 11 | RBN | — | CB* = {10, 0, 11} |
| . . . | . . . | . . . | . . . | . . . | . . . | . . . | . . . | . . . |

For context, the builder could be presented with the completed mesh shown in FIG. 11F, and the encoder in the builder could develop the encoding sequence shown above by defining different triangle strips within that mesh. In the real-world mesh example shown, there are 5 triangle strips (hatched differently in the drawings) that need to be encoded.

The first triangle, 0, is always {0,1,2}. See FIG. 10A. The topology encoding used for this first triangle is based on what the next triangle needs. Here the next triangle is {0, 2, 3}, so a topology of {0, 1, 2} that has a vA start works. See FIG. 10B.

The second triangle at {0, 2, 3} is an AC* match with the first triangle—which means it is a Left+vA according to the table above. It is using a new index, which we know as the index is equal to the above described 3+PrefixSum (New)=3+0=3. Thus, this is an LAN token. The topology for an AC* match is AC* or {0, 2, 3} in this case. See FIG. 10B.

The third triangle at {2, 4, 3} is a B*C match with the second triangle which means it is a Right+vB. It also uses a new index; it's third vertex is equal to 3+PrefixSum (New)=3+1=4. This is then an RBN token. The topology for a B*C match is CBD, which means this has a {3, 2, 4} encoding upon which the next triangle bases its choices. See FIG. 10C.

The triangles continue in this fashion. When we get to the 9th triangle (index 8) at {5, 4, 9}, it is a B*C match the previous triangles {5, 9, 8} that has a topology matching encoding of {8, 5, 9} due to rotation. So it has a Right+vB action. See FIG. 10I. But new for this one is the reuse of vertex 4, which is <3+PrefixSum (New)=3+7. This triangle will be set to Existing and use the RBE token.

The next triangle (index 9) does not match two of the vertices from the previous triangle and so it is a start triangle that explicitly specifies its 3 vertices. See FIG. 10J. Note that only one of the vertices is new so only one new explicit vertex value (as opposed to vertex index) needs to be stated. The start token defaults to a vA rotation. In this case, the next triangle at index 10 does not change the rotation of the triangle. See FIG. 10K.

And so on. Triangle meshes of arbitrary size and complexity can be encoded in this way.

### Example Decoding

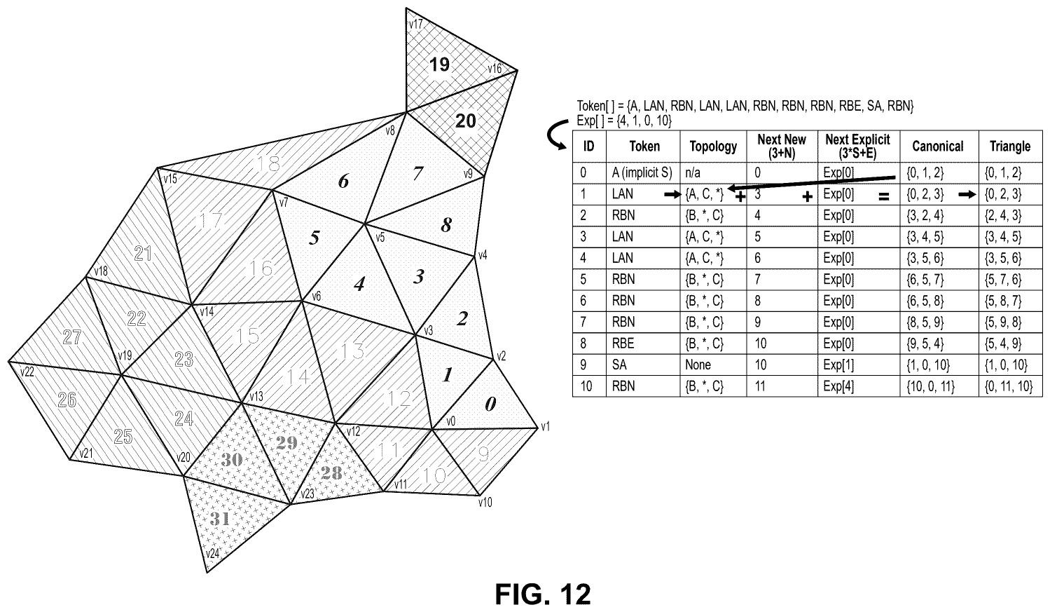

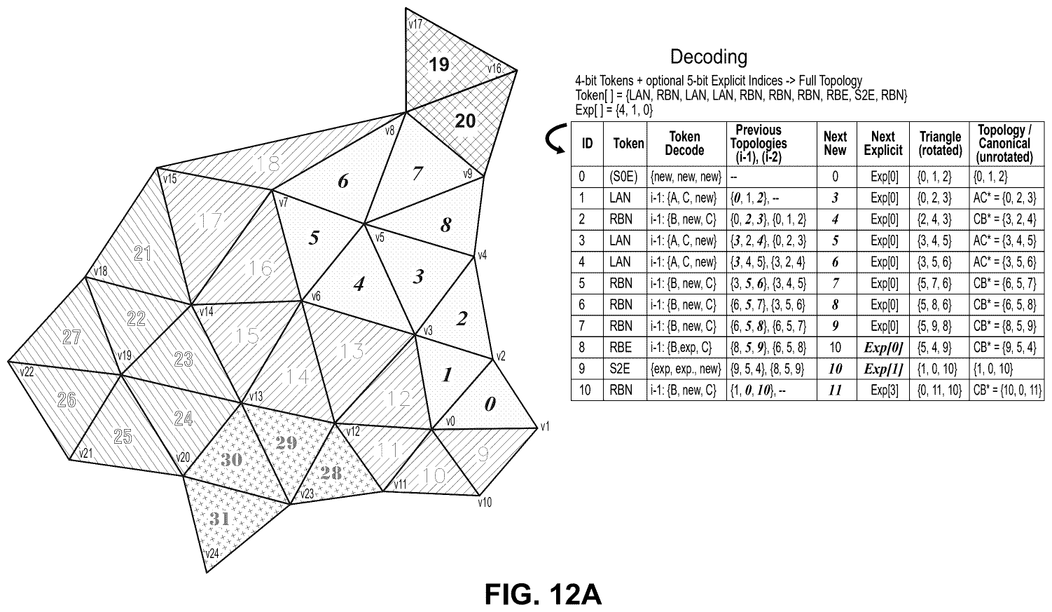

As FIGS. 10A, 12, 12A show, to decode the above example, we start with the A token. The first triangle by default is {0, 1, 2} and with A as its rotation, the topology is {0, 1, 2} as well.

The second token, LAN, creates a triangle off the left edge of the start triangle, {0, 2}, with a new vertex. That is then {0, 2, 3}. The rotation is vA, so the same order is used for the actual triangle. See FIG. 10B.

The third token, RBN, creates a triangle off the right edge, {3, 2}, again with a new vertex. That is then {3, 2, 4}. The rotation is vB which means we need {2, 4, 3} for the actual triangle instead of the canonical or topological {3, 2, 4}. See FIG. 10C.

This decoding continues in the same manner. When we get to the 9th triangle, index 8 (FIG. 10I), we get our first “Existing” encoding which involves looking up the index from the Explicit Index array. The implicit index into that array is given by the PrefixSum (3*Start, 1*Existing), which in this case is 0. Hence we pull out the index of 4, which gets added to the two implicit indices to give us the canonical or topological triangle {9, 5, 4} (see FIG. 10I). Rotation at vB produces the actual triangle {5, 4, 9}.

The next triangle is a start triangle and pulls out the next 3 explicit indices from the Explicit Index array. Those are 1, 0, and 10, giving us the triangle {1, 0, 10}. See FIG. 10J. And so on. Triangle meshes of arbitrary size and complexity can be decoded in this way.

### Example Decoder

An appendix shows pseudocode for one example decoder. Such algorithm can be implemented straightforwardly in circuitry of a hardware decoder or codec, which can be pipelined and include multiple parallel pipelines for concurrent parallel decoding of different topology token streams. Such a hardware circuit receives as input a string of tokens and an explicit index array (stored in one or more buffers). The circuit reads a token and tests whether it is degenerate. If yes, the circuit ceases decoding that token and reads the next token for decoding. If the token is not degenerate, the circuit may test whether the token is an S3E start token. If yes, the circuit will access the next three explicit indices in the explicit index array (which may be “new” or “reused”), and generates triangle and topology outputs which match. If the circuit finds the token is not an S3E start token, then the circuit tests whether it is an S2E start token. If the token is an S2E start token, the circuit reads the next two explicit indices in the array (which once again may be “new” or “reused”) and generates triangle and topology outputs. If the circuit determines the token is not an S2E start token, then the circuit determines whether the token is an S0E start token. If the token is an S0E start token, the circuit will advance 3 explicit indices (all of which are “new”) in the array. If the circuit determines the token is not an S0E token, then it determines whether the token is a Left, Right or Turn Back token. If so, the circuit advances the topology accordingly. The circuit then outputs any new triangles, and returns to read and decode another token. When there are no more tokens to read and decode in the current stream, the circuit may cease decoding and wait for a new token stream.

It is noteworthy that in the example embodiment above, the decoder circuit needs only to retain two explicit indices (a relatively small number of bits) in hardware at any given time.

### Example Toy Encodings

This section details some toy encodings to illustrate various modes.

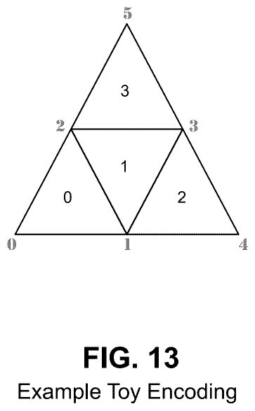

In the FIG. 13 example, we show the use of “Turn Back”. Triangle 3 does not share an edge with triangle 2, so we need to go back to triangle 1 to find a shared edge. In this case the tokens would be: [A, RAN, RAN, GB, LAN]. (Note the choice in A here for all after the first triangle is an arbitrary one based on how we assign the vertices to the triangle.)

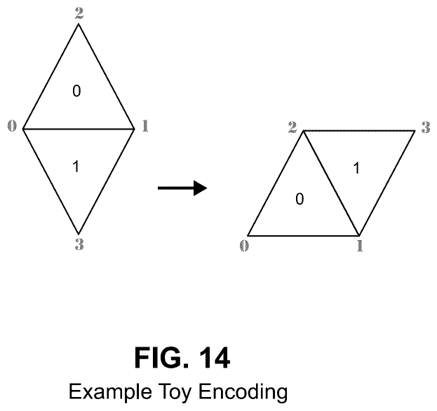

In the FIG. 14 example, we show a non-A start for the first triangle. Triangle 0 at {0, 1, 2} shares an edge with triangle 1 at {1, 0, 3}. But it is not an edge that we can choose topologically. Instead, we rotate triangle 0 to be {1, 2, 0} at which point we can say that triangle 1 is a left from the start. In this case, the tokens are [B, LAN].

Specifically:
Triangle 0 is {0, 1, 2}
Triangle 1 could be {2, 1, 3} or {1, 3, 2} or {3, 2, 1}
   a. Winding is preserved in all cases
Topologically, triangle 1 is considered as {2, 1, 3} where vA=2, vB=1, and vC=3
Triangle 1's encoding will take into account which vertex should be first:
{2, 1, 3}→ [ISA, RAN]
{1, 3, 2}→ [ISA, RBN]
Note that the {3, 2, 1} triangle rotation is not supported directly. For that, a Start would be required at the cost of extra bits.
   a. These are present, but rare.

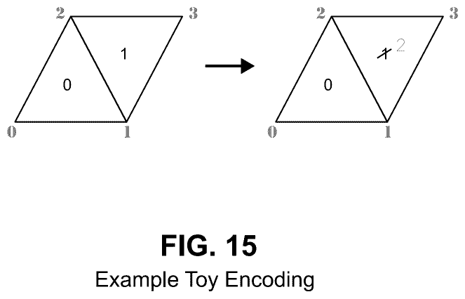

In the FIG. 15 example, we introduce a degenerate triangle so that the triangle range indexing can start at the second triangle. The sequence here would have been [A, RAN], but to get the second triangle to have an index of 2 instead of 1, we introduce a degenerate with [A, DG, RAN]. This costs an extra 4-bits in the encoding in one specific embodiment, but proper range construction can help performance by avoiding excessive bloat of bounding boxes to reduce the number of false positive intersections.

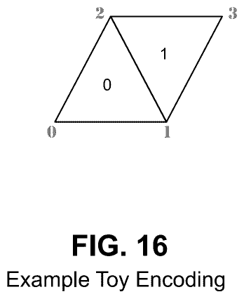

In the FIG. 16 example, we show again how rotation can work to encode multiple versions of an attached triangle. Triangle 0 is {0, 1, 2}. But triangle 1 could continue the triangle strip by being {2, 1, 3}, {1, 3, 2}, or {3, 2, 1} and still have the proper winding. Topologically, the attached triangle is considered {2, 1, 3} where vA=2, vB=1, and vC=3. For the various valid rotations above, the token for triangle 1 would be RAN, RBN, or RCN respectively given the start as the vA, vB, or vC in the topologically defined rotation.

### Additional Example/Embodiment

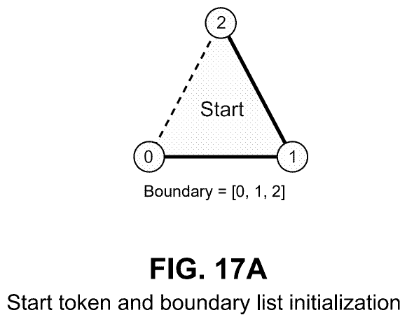

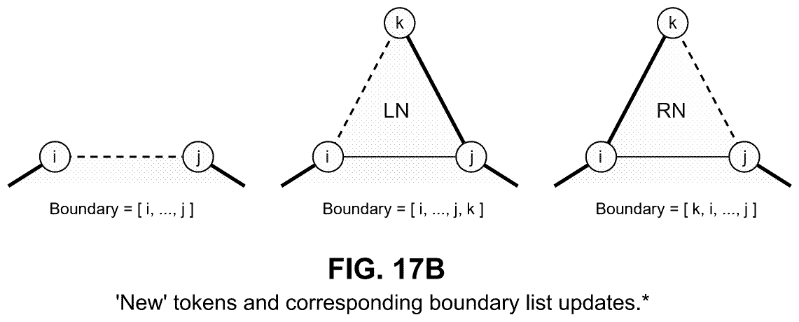

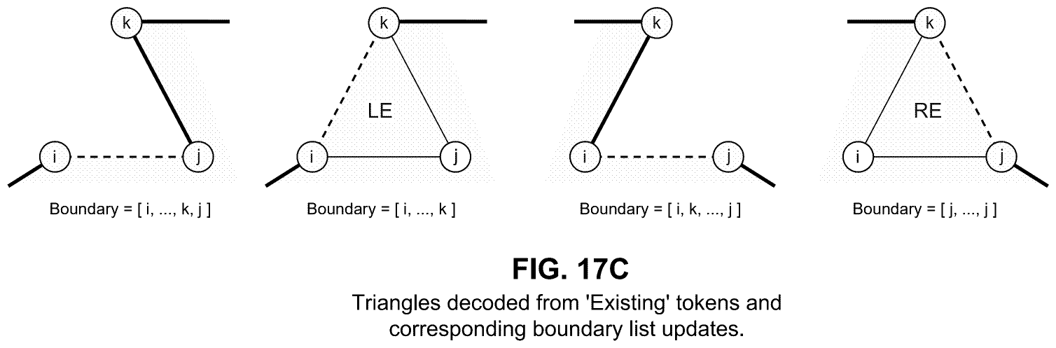

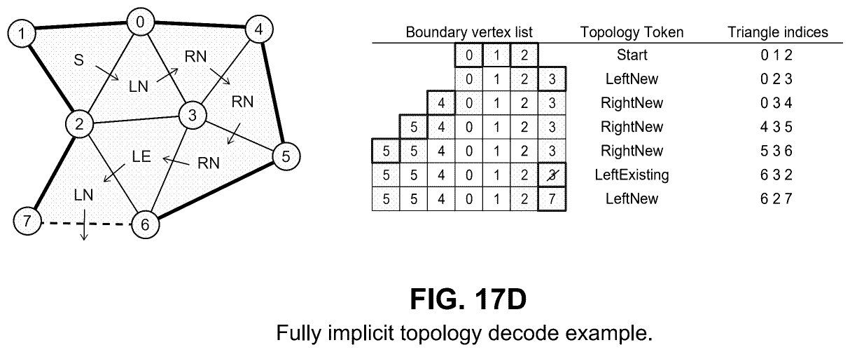

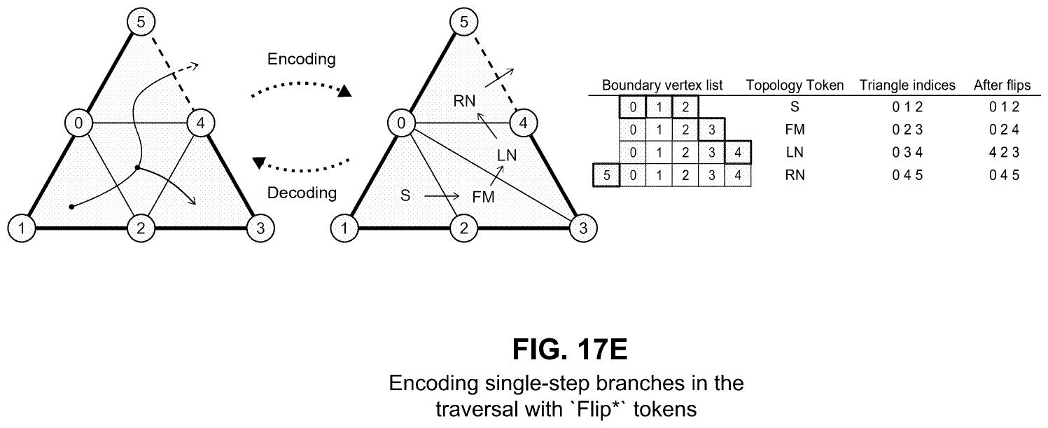

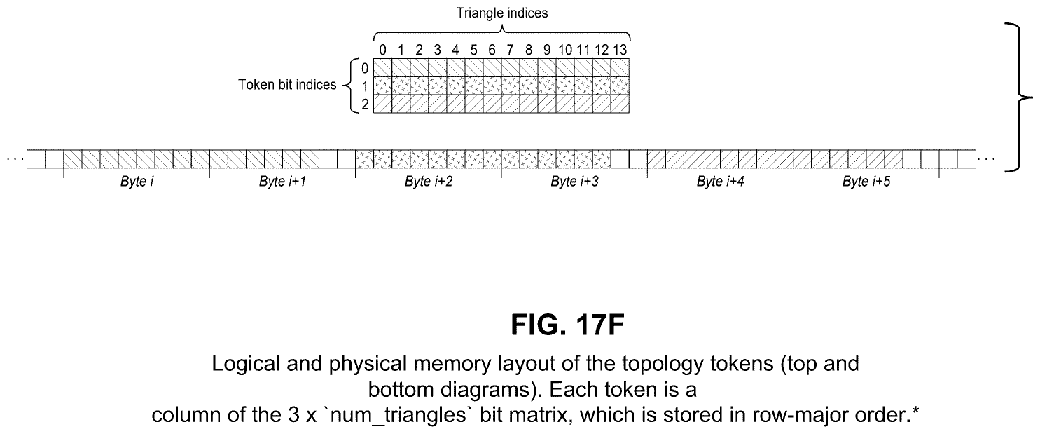

FIGS. 17A-17F and associated following discussion summarize the above topology encoding/decoding information in another embodiment:
1. The topology of a triangle cluster is encoded as a collection of generalized strips. Each strip encodes a connected group of cluster triangles as a traversal of the triangle adjacency graph and describes how the mesh boundary evolves during the traversal.
2. A generalized strip is stored as a sequence of triangle tokens that describe how each triangle is connected to the predecessor, how its vertex indices are decoded, and which boundary edge becomes the next active edge that connects to the next triangle. To facilitate encoding of a broader class of mesh traversals, we support traversals with branches where each branch can visit a single triangle before backtracking; this mechanism is implemented with special tokens that encode diagonal flips within quads formed from 2 consecutive triangles (see the Backtracking section below for details).
3. An example dictionary of topology tokens is described in the following table:

| Token | Extended Token | Description |
|---|---|---|
| ‘S’ | ‘Start’ | Start a new strip by forming a triangle with 3 new vertices; set the |
| | | active edge as the edge connecting the first and third vertex of the |
| | | new triangle |
| ‘LN’ | ‘LeftNew’ | Add a triangle by inserting a new boundary vertex connected to the |
| | | active edge and move the active edge to the left |
| ‘RN’ | ‘RightNew’ | Add a triangle by inserting a new boundary vertex connected to the |
| | | active edge and move the active edge to the right |
| ‘LE’ | ‘LeftExisting’ | Add a triangle by connecting the active edge to the boundary vertex |
| | | immediately to its right and move the active edge to the left |
| ‘RE’ | ‘RightExisting’ | Add a triangle by connecting the active edge to the boundary vertex |
| | | immediately to its left and move the active edge to the right |
| ‘FM’ | ‘FlipMatchNext’ | First triangle in a quad with a flipped diagonal. Interpret as the same |
| | | direction of the next token and the same new/existing vertex policy |
| | | of the next token |
| ‘FN’ | “FlipNegateNext’ | First triangle in a quad with a flipped diagonal. Interpret as the same |
| | | direction of the next token and the opposite new/existing vertex |
| | | policy of the next token |

4. Each token describes how a triangle is decoded by adding a third vertex index to the current active edge and updates the boundary list and active edge. The ‘Start’ token is interpreted as ‘LeftNew’ with the boundary vertex list initialized to a pair of new vertices. Vertices are re-ordered according to the first time they are referenced in the compressed strip so that the corresponding indices can be computed implicitly by incrementing a counter three times for each Start token and once for each ‘*New’ token. The first start token of a triangle cluster is not explicitly stored.

### Topology Decoding

5. At decode time, the mesh boundary is kept as a sorted list of boundary vertex indices, with the first and last element in the list encoding the current active edge, i.e. the boundary edge that the next triangle will connect to. In the diagrams of FIGS. 17A-17C, boundary edges are drawn in solid line, and the current active edge is highlighted with a dotted line.

### Start Token and Boundary List Initialization.

6. A ‘Start’ token (see FIG. 17A) clears the boundary list and pushes 3 new vertices in triangle order, implicitly setting the third edge as the active edge after the token is processed.

### ‘New’ Tokens and Corresponding Boundary List Updates.*

7. ‘LeftNew’ (‘LN’) and ‘RightNew’ (‘RN’) tokens (FIG. 17B) add a new triangle with a new vertex and update the boundary list by respectively pushing the new vertex index at the back (′LN) or at the front (′RN) of the list. Note that a ‘LeftNew’ token sets the active edge to the left edge of the new triangle, while a ‘RightNew’ token sets it to the right edge.
   Triangles Decoded from ‘Existing’ Tokens and Corresponding Boundary List Updates.*
8 ‘LeftExisting’ and ‘RightExisting’ tokens (FIG. 17C) add a new triangle with an existing boundary vertex and update the boundary list by respectively popping the last (‘LN’) or the first (‘RN’) element of the list.

### Fully Implicit Topology Decode Example.

9. Each line in the decoding table corresponds to a triangle, with the corresponding vertex references highlighted in the boundary list. Note that vertex indices are progressively numbered in order of insertion in the boundary list.*
10. FIG. 17D also illustrates the encoding of a simple mesh topology. In this example, when the traversal reaches triangle 5, we can emit a ‘LeftExisting’ token since the third vertex with index 2 is adjacent to one of the vertices on the current active edge (6 and 3) in the boundary list. When updating the boundary, we pop vertex 3 since it no longer lies on the boundary.

### Illegal Sequences

11. Token pairs corresponding to boundary list updates where a vertex is pushed and then immediately popped from the same end of the list, e.g. ‘RN’ ‘RE’ or ‘S’ ‘LE’, would encode the same triangle twice with inverted winding. These bigrams are considered illegal and not supported in one embodiment.

### Backtracking

12. The example embodiment adds support for encoding branches in the traversal with a simple backtracking mechanism. For decoding performance reasons, consecutive backtracking tokens are not allowed in one embodiment.
13. *FIG. 17E shows encoding single-step branches in the traversal with ‘Flip*’ tokens. The vertex indices of the triangles involved in the diagonal flip are re-shuffled to flip the diagonal and restore the input topology.*
14. Backtracking steps are implemented as flipped edges within a quad. FIG. 17E shows an example of using a ‘FlipMatchNext’ token to encode a traversal branch. Note that branching right and backtracking is always encoded with two ‘*Left’ tokens and a diagonal flip, and similarly branching left is always encoded with two ‘*Right’ tokens and a diagonal flip. Therefore, the bigrams consisting of a ‘Flip*’ token and one of the directional tokens ‘Left*’ or ‘Right*’ are sufficient to describe all possible combinations of *New′ and ‘*Existing’ pairs involved in a diagonal flip: See the following table:

| Bigram | Interpreted as |
|---|---|
| ‘FM’ ‘LN‘ | ‘LN’ ‘LN’ with flipped diagonal |
| ‘FM’ ‘RN’ | ‘RN’ ‘RN’ with flipped diagonal |
| ‘FM’ ‘LE’ | ‘LE’ ‘LE’ with flipped diagonal |
| ‘FM’ ‘RE’ | ‘RE’ ‘RE’ with flipped diagonal |
| ‘FM’ ‘LN’ | ‘LE’ ‘LN’ with flipped diagonal |
| ‘FM’ ‘RN’ | ‘RE’ ‘RN’ with flipped diagonal |
| ‘FM’ ‘LE’ | ‘LN’ ‘LE’ Illegal sequence |
| ‘FM’ ‘RE’ | ‘RN’ ‘RE’ Illegal sequence |

### Strip Reconstruction

15. When decoding the vertex indices from a topology token, the indices corresponding to the vertices of the active edge always appear in the first two positions of the triplet, to ensure that the traversal path can always be reconstructed by looking at matching indices in consecutive triangles. Diagonal flips apply a deterministic re-shuffling of the vertex indices to restore the original topology and satisfy the same active edge and reconstruction property of regular tokens.
16. A topology data blob is specified as a 3 x [symbol] num_triangles [symbol] bit matrix stored in row-major order with columns representing the ordered sequence of topology tokens. The row bits are tightly packed, and each row is byte-aligned, as shown in FIG. 17F. The topology data does not specify a header, since its interpretation only requires the number of triangles which will be provided as external data depending on the context and use-case. Implementations support clusters of up to 128 triangles and 256 vertices.

### Vertex Compression

This section details new geometric vertex compression options. By way of further explanation, fixed block sizes bring more overhead, when the clusters that developers generate in their art pipeline are turned into self-contained blocks. One fairly high memory cost in geometric compression are vertices. Fixed block sizes tend to reduce the effective vertex re-use. This is due to less geometry being represented in a smaller fixed size block, and therefore vertices that are shared between blocks are redundantly stored more often. Whilst the same is true for breaking a mesh into clusters, they do allow for a larger vertex reuse window. This is also beneficial to rasterization or other geometric processing, where GPU's operate in groups of fixed number of threads to process vertices and triangles. There is also an interaction between vertex positions and their shading attributes where a higher re-use improves storage efficiency.

Lossless encoding is especially beneficial for CAD (computer-aided design) and DCC (digital content creation, such as production rendering) applications, which cannot tolerate decreases in quality due to quantization or other lossy compression schemes. At the same time, it achieves a good compression ratio by exploiting spatial locality. This compression ratio increases if the input data is quantized. It should be noted here that compression can be considered a form of encoding, and decompression can be considered a form of decoding. Thus, a “codec” can be used to both encode and decode triangle data as described herein. Meanwhile, a builder may be considered to be a “compressor” or an “encoder”, and the ray tracing and/or rasterization or other image processing hardware and/or software in example embodiments includes circuitry or other processing arrangements that comprise a “decompressor” or “decoder.” Since example embodiments provide lossless encoding/decoding, the decoder is able to recover from the data stream an exact copy of the triangle data provided to the encoder.

To increase hardware efficiency, the following vertex representation operates on the bits of the floating-point representation of each vertex coordinate, interpreted as an integer. Decoding then amounts to a handful of bitwise operations and integer additions. This bitwise representation also ensures storage efficiency: the set of representable values is exactly the set of all e.g., 32-bit floating-point values. Given a vertex index, the decoder reads a *base value* and the *vertex delta* from the compressed cluster, and combines these to get a ‘uint3’. This ‘uint3’ is then bit-cast to a ‘float3’, which is the vertex position. The encoder performs the same steps in reverse.

While the encoder compresses all vertices in a cluster at once to have the information to determine optimal compression parameters, a small subset of these parameters can be used in the *prebuild info* to obtain an upper bound on the number of bytes required to store this cluster in an acceleration structure.

Example embodiments do not require or perform any quantization. At the same time, its compression ratio increases if the input positions are quantized, regardless of whether the positions were quantized using *fixed-point quantization* or *floating-point quantization*. In other words, an app can quantize vertices however it wishes, and the example embodiment will losslessly compress it as best it can; apps are not required to use a specific quantization algorithm, and the most common method of quantization (fixed-point) works well. Finally, it's worth noting that the example non-limiting embodiment compression codec can achieve a decent compression ratio without any quantization at all. Even if vertices' mantissas are totally random, because clusters are usually spatially local, their higher-order bits are usually correlated and so delta encoding can use a precision of less than 32.

### Per-Component Shifts

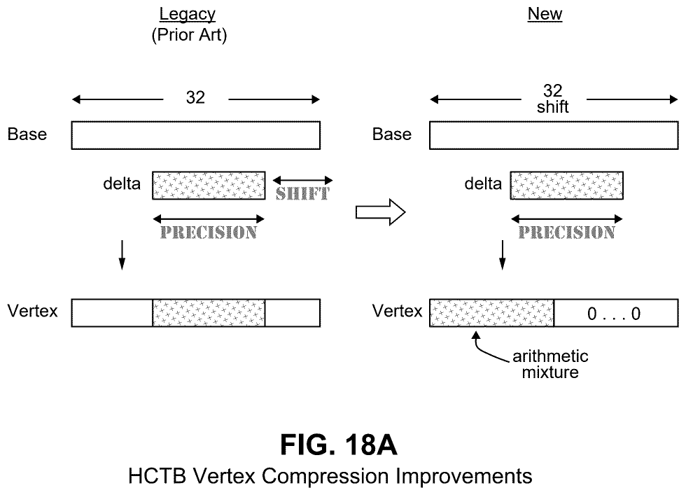

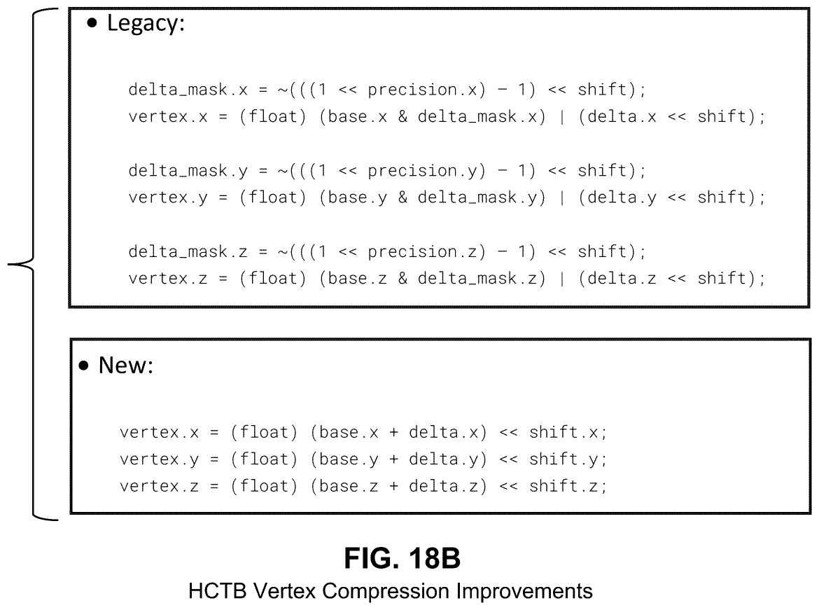

FIGS. 18A & 18B show a prior implementation as well as a new one. As FIG. 18A shows, previous formats used 32-bit base vertex values for each X, Y, Z vertex coordinate component, and provided single delta shift value (logical replacement) across all X, Y, and Z vertex coordinate components. This leads to waste when the quantization across the vertices is different.

With per-component shifts, we can take advantage of different quantization per component. In embodiments herein, there are now three shift values, one for each vertex coordinate component:
shift X
shift Y
shift Z.

Example embodiments derive vertex values from these per-component shift values such as follows:

$$\begin{matrix}vertex . x = ( float ) ( base . x + delta . x ) ≪ shift . x \\ vertex . y = ( float ) ( base . y + delta . y ) ≪ shift . y \\ vertex . z = ( float ) ( base . z + delta . z ) ≪ shift . z .\end{matrix}$$

Thus, the new arrangement in example non-limiting embodiments provides per-component shift values instead of prior single shift values across all three components (and the shift is performed on both the delta and on the base). The new arrangement in example non-limiting embodiments further provides an arithmetic operation instead of the prior mask-based logical replacement operation.

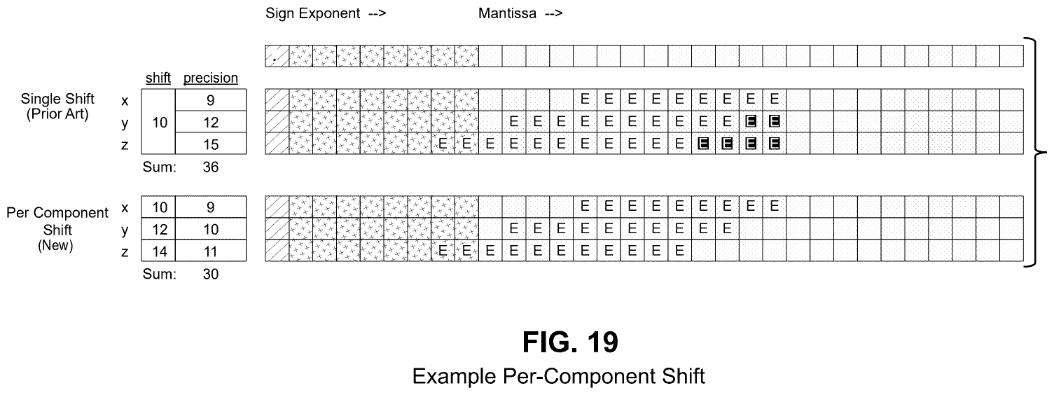

For example, in the FIG. 19 fabricated diagram, the per-component unique bits are specified by cells filled in with an E. With a shared common shift of k, each component gets to drop only the lowest k bits. But if say Y and Z have some additional bits that are common across all vertices, here specified by white Es, then there are extra bits that ought to be stored. This need for additional storage of the white E's is eliminated in the per-component shift approach shown on the bottom of the Figure because each component can now be shifted by an amount that is independent of the amount of shift of the other two components.

By allowing a per-component shift, each of the X, Y, and Z components can be maximally efficient in storage, saving a number of bits per vertex. This can result in significant storage efficiency improvements when encoding highly quantized vertex data exhibiting significantly different quantization (and thus shift amounts) across the different vertex components. The specification of two more shift values costs a few additional overhead bits total across all triangles and vertices but it is easy to make up the overhead bits by amortizing them across a larger number of vertices.

### Base Vertex Shortening

In the case of highly quantized data, the lower bits are often 0. The per-component shifts discussed above generally eliminate 0 LSBs. If we further require that the shifted off bits are all 0's, then the base vertex does not need to store those as they can be implicitly rematerialized. It is thus possible to shorten the Base Vertex by the same amount as the per-component shifts (so long as Shift covers only 0 LSBs). The stored Base Vertex thus is set to a length corresponding to the number of bits of the shifted delta information that are non-zero.

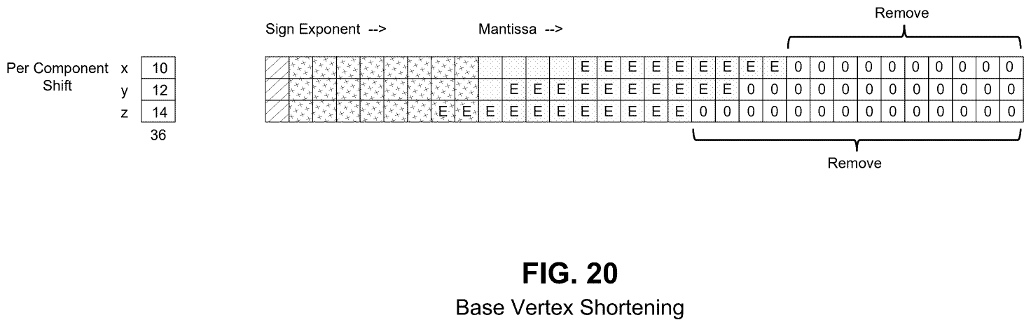

Using the same fabricated example, we can now shorten the base vertex by a large number of bits versus the full 3-component size. Because the shift amounts can now be different for the different components, the base vertex shortening amount will also be different for the different components, i.e., in this example the base vertex X component can be shorted by 10 zeros, the base vertex Y component can be shorted by 12 zeros, and the base vertex Z component can be shortened by 14 zeros. See FIG. 20. The calculated shift values can be used by the decoder to fill back in the now-missing zeros when recovering the vertex values.

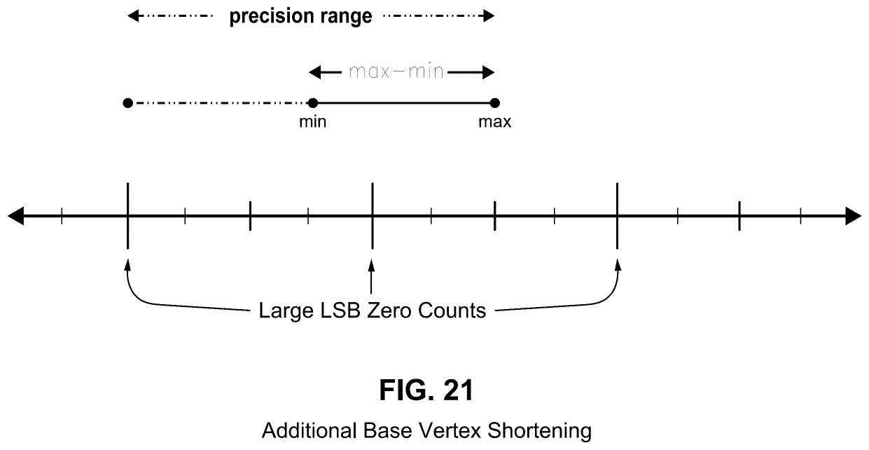

Since the base vertex value in example implementations is not directly used as a vertex by any triangle in the block, we can set it however we might want. The number of precision bits needed for any component is ceiling (log 2 (max−min)). If the min and max are not maximally separated (i.e., the ceiling portion above has an effect), then the base vertex can be something other than the min value without increasing the precision bits. The base vertex value can thus be set anywhere between min and “max−(1<<precision)”. Any base value in that range works as well as any other, since the precision is the same. Min values would be non-zero, but still within the allowed precision. As shown in FIG. 21, one embodiment chooses a base value with the most 0 LSBs, encodes an extra base vertex shift, and then shortens the base vertex. Further, this can be done for any or all of the components, for example:

$$\begin{matrix}vertex . x = ( float ) ( base . x ≪ extraShift . x ) + delta . x ) ≪ shift . x \\ vertex . y = ( float ) ( base . y ≪ extraShift . y ) + delta . y ≪ shift . y \\ vertex . z = ( float ) ( base . z ≪ extraShift . z ) + delta . z ≪ shift . z .\end{matrix}$$

### Arithmetic Delta Encoding

Example embodiments provide an additional vertex compression component: use integer arithmetic delta compression instead of logical bit replacement. By using arithmetic deltas, the carry over from the add can be used to flip bits higher in the vertex without having to specify all values in between (in other words, arithmetic deltas with carry propagation can affect more bits than just logical deltas can).

In example embodiments, the base vertex is encoded as the min value of each component across the block. By doing this, the deltas used to derive individual vertex components will always be positive. Which, as explained below, means that the delta values can be unsigned.

As such, the “base vertex” does not (in the general case) specify vertex 0 (or any other particular vertex) and vertex 0 is instead explicitly included in the deltas (i.e., additional bits now are used to specify deltas for deriving vertex 0 from the base vertex values). In other words, instead of being an actual vertex that one of the triangles in the block might use, the base vertex in one embodiment is now a mixture of minimum component values across the triangle range (i.e., one vertex of one triangle in the range may contribute the base vertex X component, another vertex of another triangle in the range may contribute the base vertex Y component, and yet a third vertex of yet another triangle may contribute the base vertex Z component). By specifying the base vertex as the min value of each component across the block, the encoded deltas can be unsigned values (which saves overhead that would otherwise be needed to specify whether the delta component value is to be added to or subtracted from the base component value). Once again, when amortizing over the three different components of a large number of vertices, the savings of not specifying a sign bit for each delta value nets storage savings even though an additional delta value is now included for vertex 0.

In other embodiments, the base vertex could be specified as the max value of each component across the block to once again result in unsigned delta values (each delta in that case would be subtracted from rather than added to the base vertex component values). And in a more general setting, there is no reason why the base vertex must be set to have components that match any specific component values of any vertices in the range. In particular, one embodiment might set the base vertex component values to be at points between min and max vertex component values across the range. See FIG. 21. Then, it is possible to use 2's complement arithmetic (e.g., instead of signed magnitude arithmetic) to derive the individual vertex component values from those base vertex component values (see below). This may enable the builder/encoder to optimally decrease the lengths of the stored parameters to achieve further compression ratio increases.

In example embodiments, the precision of any deltas is simply the number of bits required to encode the difference between the maximum value of each component across the block minus the minimum value of each component across the block.

In one specific embodiment, each vertex delta component is encoded in the following manner (including shifts):

$$\begin{matrix}delta [ i ] . x = ( float\_as \_int ( vertex [ i ] . x ) - float\_as \_int ( base [ i ] . x ) ) ≫ shift . x \\ delta [ i ] . y = ( float\_as \_int ( vertex [ i ] . y ) - float\_as \_int ( base [ i ] . y ) ) ≫ shift . y \\ delta [ i ] . z = ( float\_as \_int ( vertex [ i ] . z ) - float\_as \_int ( base [ i ] . z ) ) ≫ shift . z\end{matrix}$$

As noted above, each vertex component is decoded as:

$$\begin{matrix}vertex [ i ] . x = float ( ( base [ i ] . x + delta [ i ] . x ) ≪ shift . x ) \\ vertex [ i ] . y = float ( ( base [ i ] . y + delta [ i ] . y ) ≪ shift . y ) \\ vertex [ i ] . z = float ( ( base [ i ] . z + delta [ i ] . z ) ≪ shift . z )\end{matrix}$$

In hardware in one embodiment, the decoder provides additional unsigned integer adders to the decoder to perform the above decoding operations.

### 2's Complement Arithmetic

In an embodiment above, the base vertex is set to the signed minimum as described, and the delta offsets are unsigned. It is common to convert floating point to integer representations for comparison purposes, but integer mapping may raise sign bits. The use of two's complement arithmetic can eliminate that concern.

When triangle blocks as described above have mixed sign, treating the signed-magnitude format directly as an integer is correct but not as efficient as if it were in 2's complement. To improve compression, we can translate to 2's complement (and back again) to get a compression advantage. See the following example pseudocode:

```
int signedMagnitudeTo2sComplement(int smValue) {
  if (smValue < 0) {
    return −(smValue&0x7fffffff); // clear the sign and negate
  }
return smValue;
}
int twosComplementToSignedMagnitude(int tcValue) {
  if (tcValue < 0) {
    return 0x80000000|(−tcValue); // negate and set the sign
  }
return tcValue;
}
```

Such conversion is simple to perform in software and very straightforward to implement in arithmetic circuitry of a hardware decoder or codec.

In one embodiment, the AS builder determines the shift by tracking the minimum and maximum per component across the block. The builder sets precision to the bits needed to encode (max-min), and sets the shift to the per-component minimum number of LSB zero values. The builder may be able to assume the developers created triangle clusters such that the triangles within have a high level of spatial and topological connectivity.

### Binned Setting of Base Vertex Values

A possible further technique is to use table-driven binning to determine optimal base vertex values for a given data set. To do this, one finds the value on an interval with the largest number of inputs. On already quantized data, the widths of the arithmetic deltas tend to be narrower. For example, the majority of the base vertex values may, based on empirical observation, have 7 least significant bits for already quantized data. For unquantized data sets, on the other hand, the base vertex values are typically quite large even though they contain many zeros. An efficient mechanism to determine base vertex values appears to group zero counts into bins. In most cases, 2 bits for each of components X, Y and Z may be optimal-meaning that 6 bits for every triangle block could be used to specify how many zeros were actually coded.

This method proceeds from the proposition that there is a particular optimal mapping for every arithmetic delta value width that is stored. For example, for an unquantized input with low correlation, we may observe arithmetic delta widths that are 20 bits wide. With 20-bit-wide arithmetic deltas being added to the base values, the base values have a particular distribution which can be represented by the following bin distribution arrived at empirically through data set observation:
0-14 bits: no bits saved
15-17 bits: 15 bits saved
18 bits: 18 bits saved
19+ bits: 19 bits saved

For blocks that have an offset width of 20 bits, we empirically see an average savings of around 16 bits×3 components=48 bits. The savings are similar for quantized inputs (because its driven by offset widths, this arrangement works for both quantized and unquantized inputs; the offset widths for quantized inputs tend to be quite narrow but bit savings still result by using a binned approach).

An implementation of this approach can be table driven, with a table defining the bins indexed by arithmetic delta width to determine optimal mapping for the bins of zero savings. The table could be loadable with any desired values in order to customize the encoding and decoding for particular data sets. Across a number of input data sets, 2 bits for 4 bins appears to be a “sweet spot”. This technique can be used to provide an optimal partitioning for the difference between the min and max values with which to set the default base vertex values for a particular triangle block.

### Highly Compressed Triangle Block (HCTB) Layout

This section details a layout of an example embodiment Highly Compressed Triangle Block (“HCTB”) that includes the above features. For all diagrams detailing micro-architectural layout, the exact placement of fields is not material (they could be placed anywhere and still have the desired effect). The number of bits and precise bit encodings can also change in different embodiments.

### Whole Block Orientation

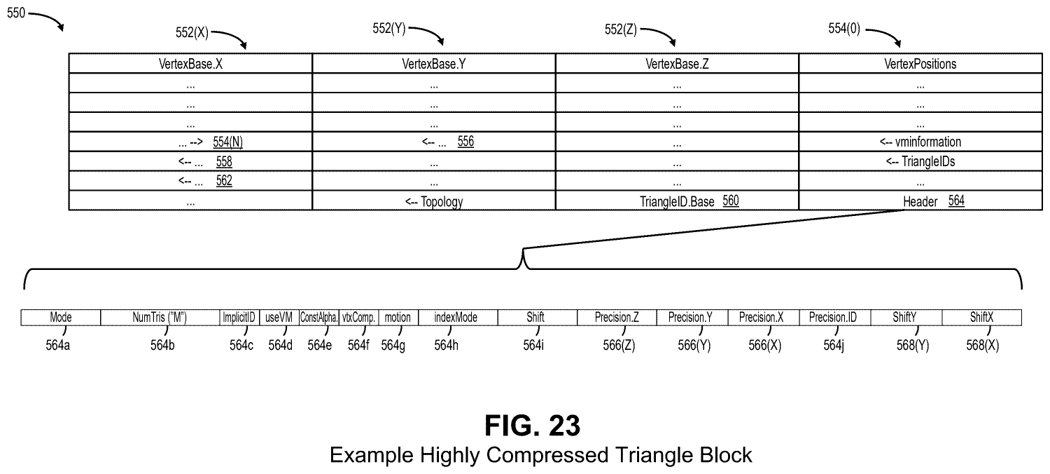

An example whole triangle block 550 can be seen in FIG. 23. In example embodiments, the triangle block 550 comprises the following parts:
Base Vertex components 552(X), 552(Y), 552(Z): A high precision base vertex (three spatial coordinates) upon which to do delta compression (either logical or arithmetic). With the addition of vertex compression options, the base vertex 552 can be either a fixed number of bits per component or a variable width per component.
Vertex Positions Array 554(0), . . . , 554(N): An array of per-vertex deltas against the base vertex, allowing a number of vertices to be derived from the base vertex component values 552
VM Information field(s) 556: Information associated with Visibility Masks (a.k.a., Opacity Micro-Maps)
Triangle IDs Array 558: An array of per-triangle deltas against a base Triangle ID 560 to encode/derive a series of triangle identifiers without the need to explicitly store them all
Base Triangle ID 560 (see above)
Topology/Vertex Indices 562: topology information to construct triangles from given vertices (may be either an implicit strip topology or an explicit indexing per triangle), e.g., using the token based encoding described above. Includes alpha and force-no-cull bits.
Header 564: Control information for what is stored and how to decode it

The vertex positions array 554 grows up from the bottom with the number of vertices stored. The VM information 556, triangle IDs 558, and topology 562 grows down from the top with the number of triangles stored. In a well-formed block, the two groups growing up and down should not cross into each other. If they do, then too many vertices or too many triangles are being stored in the block and it should be split into multiple blocks instead.

The subsequent sections will go into details on each of these parts.

### Example Header 564

An example header 564 can also be seen in FIG. 23.

Fields added or modified for HCTB include: mode 564a, num tris 564b, implicitID 564c, use VM 564d, constAlphaFNC 564e, vtxComp 564f, motion 564g, indexMode 564h, Precision.ID 564j, ShiftY 568(Y), and ShiftX 568(X):
The mode field 564a adds a new mode: highly compressed (triangle blocks).
The numTris 564b field is sized to encode more (e.g., up to 32 in one embodiment) triangles.
   In example embodiment, an additional, separate field is added in the topology section to allow even more (e.g., up to 64 in one embodiment) triangles when using a triangle strip topology. Explicit topologies use up too many bits on topology for a 64-triangle block to be likely so example embodiments provide up to a first number of triangles in the header and up to a second number of triangles greater than the first number of triangles by providing a supplemental field or indicator in a separate, topology section.
The implicit ID field 564c encodes whether the triangle ID array 558 exists to explicitly encode vertices or whether an implicit ID is used instead.
   When using implicit IDs, the ID for any triangle may be specified as the index of that triangle added to the base triangle ID 560. E.g., triangle at index 5 would be base+5, or triangle at index 0 would be base+0.
The ConstAlphaFNC field 564e specifies whether the alpha and force-no-cull bits are specified per triangle or assumed constant across the block.
   If assumed constant, the first (0 index) alpha and force-no-cull bits are used for all triangles.
The vertex compression field 564f sets whether vertices are compressed logically (legacy behavior) or arithmetically as described herein.
The motion field 564g, now separate from the mode field 564a, enables motion.
   When motion is enabled, each vertex becomes a pair that maps to the start and end key points. E.g., for a triangle specifying vertices {0, 1, 2}, the vertices used for interpolation would be triangle at key point 0={0, 2, 4} and triangle at key point 1={1, 3, 5}.
Index mode 564h enables the various vertex indexing modes: for example, 32 vertex, 16 vertex, or implicit strips.
The Precision.ID field 564j is changed to only be present when implicit IDs are disabled, saving bits when they are enabled.
The ShiftY and ShiftX fields 568(Y), 568(X) are used to specify an independent per-component shift.
   In example embodiments, these values are present only when the vertex compression mode is arithmetic.

### Vertex Positions Array 554(0), . . . 554(N)

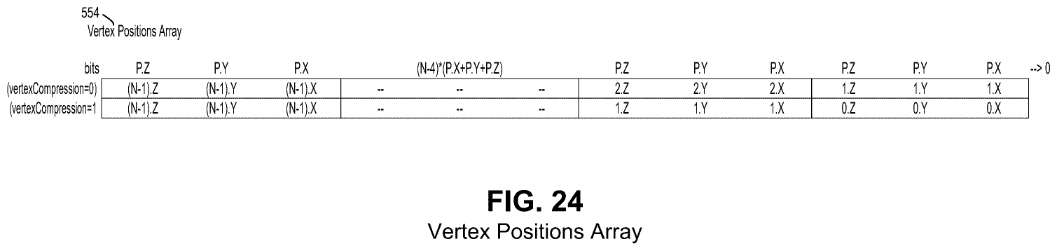

Content of the vertex positions array can be seen in FIG. 24. An noted above, the vertex positions array 554 holds the vertex delta values that are used to compute any vertex relative to the base vertex specified in fields 552. When the vertexCompression field 564f is set to arithmetic, then the first or 0th vertex is also encoded (i.e., 0.X, 0.Y, and 0.Z) and the length of the array is extended by one vertex since the base vertex field 552 now does not represent any actual triangle vertex. Additionally, when vertexCompression field 564f is set to arithmetic, the values stored here are unsigned arithmetic deltas from the base vertex versus logical bit deltas.

### Triangle IDs Array 558

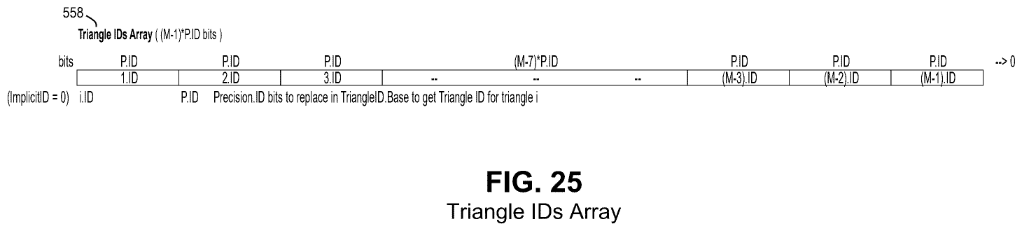

The triangle IDs array 558 seen in FIG. 25 is similar in certain respects to legacy versions, except that when implicit IDs are used, the entire array is excluded from the block. In that mode, instead of doing a logical replacement of bits in the base triangle ID 552 to calculate a triangle's ID, the index of that triangle is instead added to the base triangle ID.

### Topology/Vertex Indices

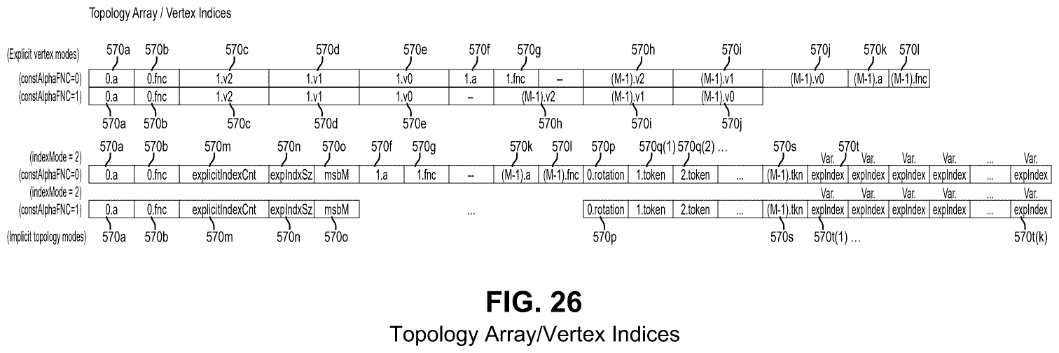

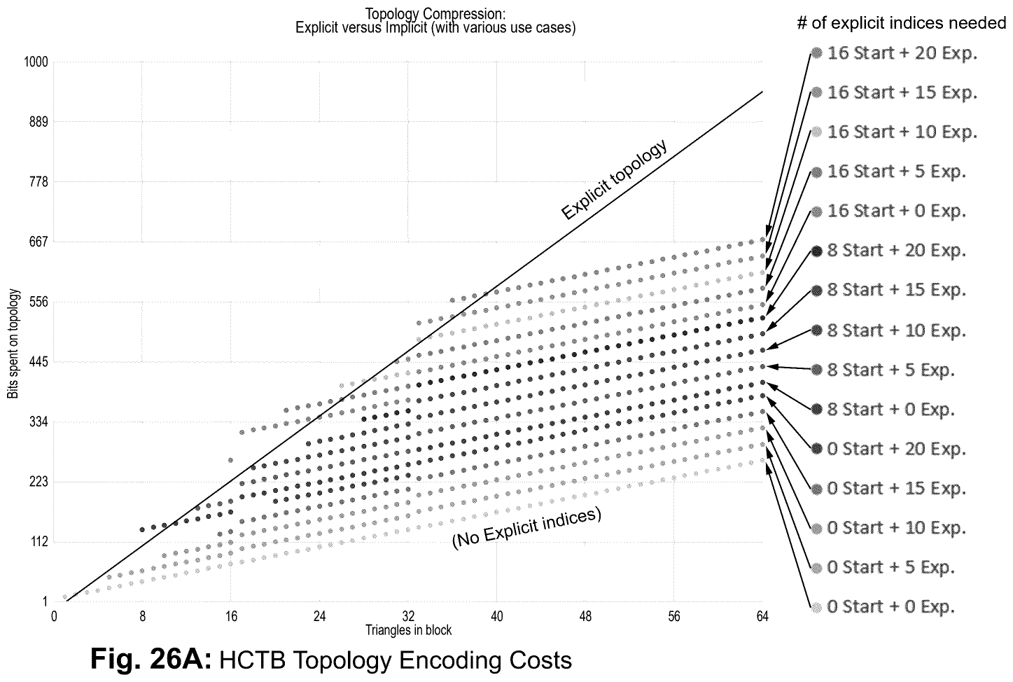

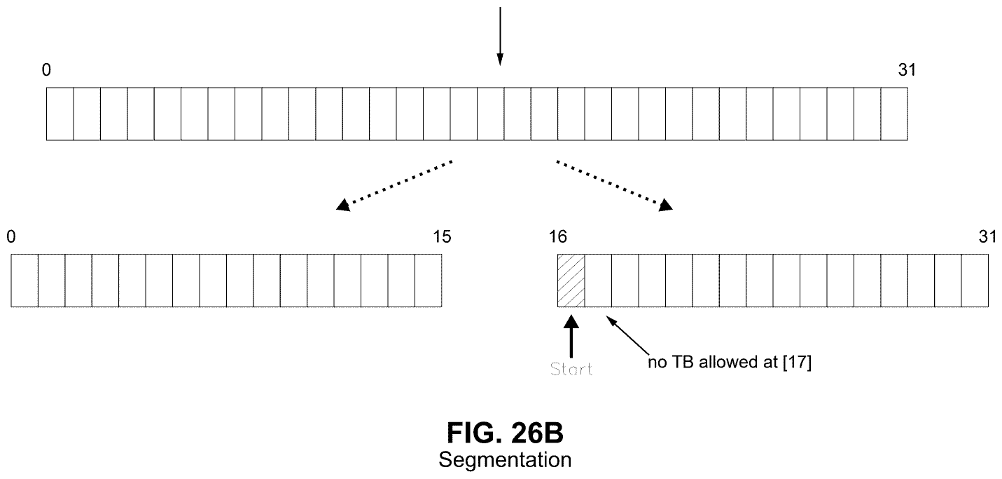

Example topology or vertex indices are shown in FIG. 26.

In both cases, the alpha and force-no-cull bits can be per triangle or could just use the 0.a and 0.fnc for all triangles.

For explicit topologies, each triangle has three indices for each of its vertices. These indices have selectable widths in example embodiments.

For strip topology, we instead use tokens. An explicit index count helps find the length of the array without having to first do prefix sums. The explicit index size allows for indexing up to a selectable number (e.g., 16, 32 or 64) vertices. The MSB M field 570O allows for setting the triangle count up to 64 instead of the typical limit of 32.

Additional example parameters shown in FIG. 26 are as follows:

| | |
|---|---|
| 0.a (570a) | Alpha for triangle 0, or for all the triangles if ConstAlphaFNC set |
| 0.fnc (570b) | Force-No-Cull for triangle 0 for all triangles if ConstAlphaFNC set |
| i.a (570f) | Alpha for triangle i (i > 0) |
| i.fnc (570g) | Force-No-Cull for triangle i (i > 0) |
| 0.v0/v1/v2 | Implicit: Vertex indices for non-motion triangle 0 are 0, 1 & 2 (0, 2 & 4 |
| | for motion triangle 0) |
| i.v2 (570c) | Vertex position array index for vertex 2 of non-motion triangle i or upper |
| | bits of vertex position array index for vertex 2 of motion triangle i; motion |
| | start key (msk) shift left by 1, motion end key (mek) shift left by 1 and |
| | add 1 |
| i.v1 (570d) | Vertex position array index for vertex 1 of non-motion triangle i or upper |
| | bits of vertex position array index for vertex 1 of motion triangle i; msk |
| | shift left by 1, mek shift left by 1 and add 1 |
| i.v0 (570e) | Vertex position array index for vertex 0 of non-motion triangle i or upper |
| | bits of vertex position array index for vertex 1 of motion triangle i; msk |
| | shift left by 1, mek shift left by 1 and add 1 |
| explicitIndexCNT | Number of explicit indices (this is used to make decoding easier by |
| (570m) | informing the encoder how many explicit indices are in explicit index |
| | array 570t |
| expIndxsz (570n) | explicit index size (in one embodiment, can be 4 bits, 5 bits or 6 bits |
| | depending on the number of vertices that can be indexed by triangles |
| | encoded in the block |
| msbM (570O) | extra triangle count most significant bit (expands # of triangles); in |
| | example embodiments this is included as a separate bit for compatibility |
| | reasons, and because implicit topology encoding is where such expanded |
| | number of triangles will come into play |
| 0.rotation (570p) | rotation of first triangle for topology purposes (0 = A, 1 = B) |
| i.token (570q(1), | token(s) for triangle i (see above) (token values 570 comprise an array or |
| 570q(2), . . . ) | stream of 4-bit token values in example embodiments); example token |
| | encoding is described above |
| expindex (570t(1) | array of explicit indices for any Existing or Start tokens (any token 570 |
| . . . 570t(k)) | needing an explicit index will point to or access an explicit index in this |
| | array 570t); this array is of variable length as shown |

FIG. 26A shows some different topology encoding costs. This graph shows there are cases where the prior explicit index topology can be more efficient than the new implicit index topology. The builder can use a calculation function to analyze the data (or try both explicit and implicit on the same triangle data and see which is smaller) and select between explicit index topology or implicit index topology. In particular, the builder can successively add triangles to the range until no more triangles fit in a cacheline sized block. It can do this for both implicit mode and explicit mode. The builder then selects between the different mode formats (explicit or implicit topology) shown in FIG. 26 for storing the triangle block data for that triangle block. Different triangle blocks can use different modes. The decoder decodes the mode indicator in the received data stream in order to determine whether to decode the triangle block as explicit topology data or implicit topology data.

Without changing the topology compression scheme above, it is also possible to introduce software-enforced rules or constraints on the builder to achieve simpler structure or increased performance of a hardware decoder, with potential expansion in later generations. For example, topology decode takes a certain amount of time: it is possible to cap the time it takes to fit in a particular hardware decoder design budget without limiting the generality of the encoding/decoding scheme for future generations of even more capable hardware.

One possible approach is to set a maximum token count at some value N. Such a limit results in segmentation of a strip based mesh into plural smaller strips each no longer than a maximum size determined by the token stream that defines the strip. See FIG. 26B. 64 triangles in one block is rare, so artificially limiting occupancy to say 48 triangles (e.g., 2.7B/triangle) is another approach.

Similarly, “forced Starts” can be used to limit strip length to a maximum number of 32 or 16 triangles, potentially resulting in simpler hardware. In one such approach, the 32nd token (or 16th, 32nd, or 48th) is forced to be a start even when it could be a continuation of an existing strip.

It is also possible to impose Forced Starts with no range overlap (i.e., don't allow any triangle range to span a forced start sub-group) in order to achieve a smaller hardware decoder footprint/complexity. This may be onerous for the builder as this forces a construction ordering to know blocks before ranges and may result in worse bounds (i.e, decrease flexibility of the builder to construct triangle ranges for the AS). However, it may simplify the decoder hardware to build say just one 32-length or 16-length decode pipe or perhaps 2×16-length decode pipeline if there is no overlap between triangles [0-31] and triangles [32-63].

Another similar approach is to impose a “no Turn Back” prohibition in the next spot (33rd, or 17th, 33rd, and 49th spots) after a certain number of tokens (i.e, 32, 16, 48, etc.)

Such a segmentation technique can be used for example to define multiple (e.g., four) smaller strips in the place of a single, larger strip. The multiple smaller strips can be decoded in parallel to achieve faster decoding and processing of the same overall triangle range than would be possible if all triangles were in a single strip. For example, four segmented strips each no longer than 16 triangles (as defined by no more than 16 tokens) can be decoded in parallel faster than a single strip of 64 triangles defined by 64 corresponding tokens. Using such segmentation techniques, it is possible to build 2× parallel 32-length or 4× parallel 16-length decode pipelines in the hardware decoder that can process the segmented triangle strips in parallel. For example, a first pipeline can decode tokens and associated triangles [0-31] in parallel with a second pipeline decoding tokens and associated triangles [31-63.] Similarly, a first pipeline can decode tokens [0-15] in parallel with a second pipeline decoding tokens [16-31], a third pipeline decoding tokens [32-47], and a fourth pipeline decoding tokens [48-63].

Example embodiments may still prefix sums with explicit index inspection to find next new and explicit indices.

### Visibility Masks (VMs)

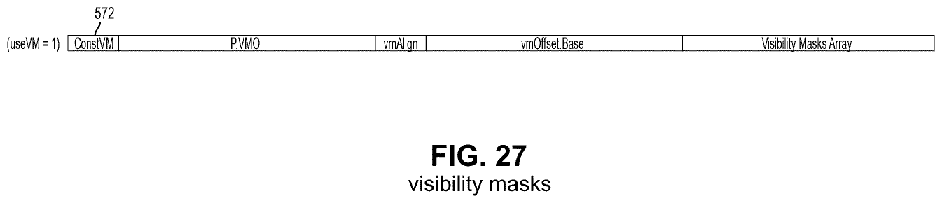

Visibility masks are described for example in US20230084570. The visibility mask content seen in FIG. 27 is similar to prior approaches except now there is a distinct field to enable VMs in the block rather than a format specifier. Additionally, the ConstVM 572 can be used to reduce the visibility masks array to a single set of entries to be used by all triangles in the block.

### Other Example Implementations

The vertex codec can be extended to a generic attribute codec by allowing a wider range of components per element and bits per component. Values could be specified per vertex or per face. When decoding, the app would specify the format of the data and whether it was decoding the value for a specific vertex or face.

Let the type of each value be specified by a DXGI format with C components where each component uses B bits. (For instance, C=1′ and ‘B=16’ for DXGI_FORMAT_R16_UNORM. Formats for which this is not clearly defined, such as DXGI_FORMAT_BCI_UNORM, DXGI_FORMAT_NV12, and DXGI_FORMAT_P8, are not allowed.) An integer that can store the values from ‘0’ to ‘B-1’ requires ‘L:=ceil (log 2(B))’ bits.

```
    Then the generic attribute header is
‘‘‘cpp
struct NVClusterAttributeHeader {
  uint32_t shift_x : L; // Shift value for x-component deltas (0 − B−1)
  // Followed by shift_y, shift_z, and shift_w, depending on C
      uint32_t precision_x : L; // Bit width for x-component deltas, minus 1 (0 − B−1)
      // Followed by precision_y, precision_z, and precision_w, depending on C
      uint32_t base_value_x : B-shift_x; // Base value for delta encoding of x components
      // Followed by base_value_y, base_value_z, and base_value_w, depending on C
    };
    ‘‘‘
```

It is then (immediately) followed (with no bit or byte padding) by a bit-packed sequence of delta codes in ascending element order. The deltas are then followed by padding up to a 4-byte boundary. This ensures that the compressed attribute data for each cluster is aligned to 32 bits.

### Supporting More Triangles Per Block

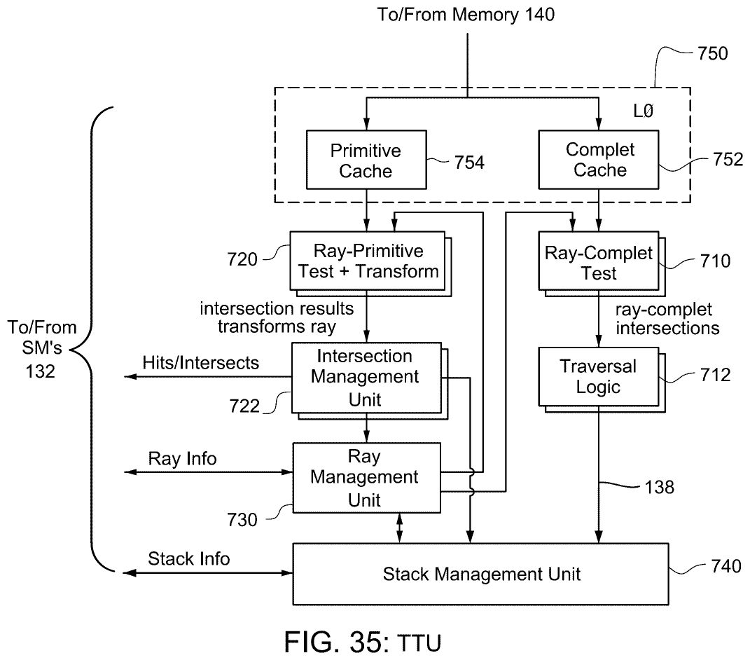

As described in U.S. Pat. No. 10,580,196, the TTU raytracing hardware (see FIG. 35) receives a query requesting a nearest intersection between a ray and a triangle range. The query may be received by the ray management block from a calling processor or may be initiated based on the result of ray-complet test performed by the ray-complet test path of the TTU. The query may request a closest hit intersection or any intersection. The ray may be identified by its three-coordinate origin, three-coordinate direction, and minimum and maximum values for the t-parameter along the ray. Generally, a triangle range is defined by (1) starting block, (2) index within that block, (3) line span, (4) index in last block. The triangle range for a particular query for the TTU may operate on one cacheline-sized block at a time and be identified in one or more stack entries of a stack management block in the TTU. In one embodiment, the ray-complet test may identify one or more intersected leaf nodes of an AS tree or graph which point to a range of triangles or items. The triangle range can be a set of consecutive triangles that start at the n-th triangle in a block of memory and run for zero or more blocks until the m-th triangle of the last block. A block may be a memory cache line. The triangles may be compressed in the cache lines, with a varying number of triangles in each cache line. A range of triangles could span over a varying number of cache lines. The triangle range may be provided in a contiguous group of cacheline-sized blocks. Each cacheline-sized block may include a header identifying the type of geometry expressed within the block and a primitive type of each primitive in the block. In one example, the header may identify the type of geometry expressed within the block and the encoding scheme (for example, compressed triangles or highly compressed triangles), the number of primitives in the block, and a set of ForceNoCull bits which indicate whether culling should be disabled for each primitive in the block, and a set of Alpha bits which indicate for each primitive in the block whether the primitive is an Alpha primitive or an Opaque primitive. The TTU may test a triangle in the triangle range for intersection with the ray. Because the block with the triangle range can encode multiple opaque or alpha primitives in any order, and the triangle range can span multiple blocks returned in arbitrary order by the memory subsystem of the TTU, the first triangle tested may not be the closest triangle to the ray origin. The ray-triangle test and transform block may test the triangle for intersection with the ray. If the ray-triangle test and transform block determines an intersection, the ray-triangle test and transform block may pass information about the intersection to the IMU. Testing the triangle for intersection may include determining whether the ray intersects an area identified by vertices of the triangle. The ray-triangle test and transform block may transform the ray into object-space coordinates of the triangle before performing the intersection test. If there is no intersection between the triangle and the ray, then the triangle can be omitted from the results and a determination is made as to whether there is another triangle in the range to be tested. If there is another triangle to be tested in the triangle range, either in the same block or another block associated with the triangle range, then the triangle-ray test may be performed on the next triangle. If there are no other triangles in the triangle range to be tested, then the ray-triangle test is complete and the results of the ray-triangle test can be sent to the calling processor or another block inside or outside of the TTU initiating the query. Returning the results may provide the parametric opaque intersection in the triangle range which is closest to the ray origin. The results may provide the opaque triangle ID, along with the t-value, and coordinates of the intersection (e.g., barycentric coordinates of the intersection). If no intersections are identified in the triangle range, the result will indicate that no intersections were found.

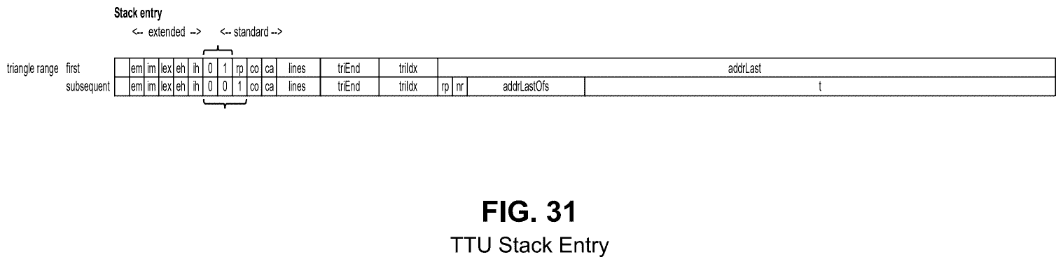

Example embodiments provide memory efficient techniques for increasing the number of triangles within such a triangle range. Specifically, a new compressed treelet (“complet”) format is used by the AS builder to represent the geometry in one embodiment, to enable ranges to index more triangles within a block. Complets use a certain number of bits per child node to encode ranges. This extends to the TTU stack layout (FIG. 31) as well (to represent new complet information within the TTU, the stack adds extra width to each of triIdx and triEnd). The TTU data paths are modified/configured to accommodate the extra widths of these parameters.

### Compressed Treelet (Complet) Representations

In addition to creating HCTBs as described above, the AS builder creates entries in the BVH that invoke the TTU to perform raytracing against the HCTBs. These BVH complet entries are compressed and are defined within a tree or graph structure of the BVH. Prior generations of NVIDIA AS builders and GPUs have supported several different kinds of formats of such complets. See for example, US20240095995; U.S. Pat. Nos. 11,508,112; 11,450,057; 11,380,041; 11,373,358; 11,302,056; 11,295,508; 11,282,261; 11,157,414; 11,138,009; 10,885,698; 10,867,429; 10,825,230; 10,810,785; 10,740,952; 10,580,196.

Briefly, since the BVH tree includes branch nodes and leaf nodes, complets similarly have branch node and leaf node configurations. The branch node complets link a parent node to one or more child nodes in the context of a hierarchical linked list, corresponding to volumetric subdivision of a parent bounding volume into child bounding volume subdivisions of the parent bounding volume. The branch node style complets enable the TTU to transverse the BVH while culling volumetric subdivisions that do not intersect a given ray being tested for intersection. Leaf node style complets also specify child bounding volume subdivisions of a parent bounding volume but additionally specify geometry (e.g., triangles) within the child bounding volume subdivisions. Leaf node style complets thus also enable such spatial culling and also provide geometry within non-culled volumetric subdivisions the TTU tests for intersection against the ray.

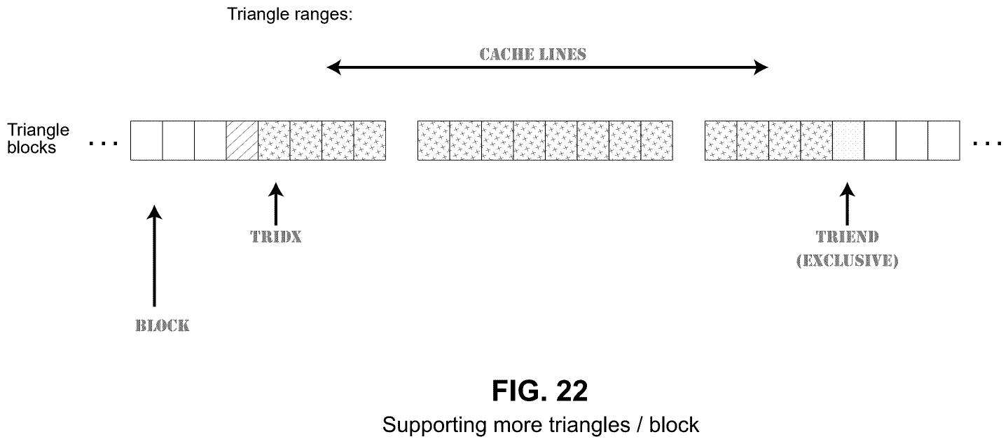

FIG. 22 shows how complet blocks can define triangle ranges by (1) starting block, (2) index within that block, (3) line span, (4) index in last block. Complets use a certain number of bits per child to encode such ranges (e.g., a first set of bits for index+a second set of bits for lines, and a further index comprising a third set of bits for starts in one embodiment). Indexing more triangles means wider indices but only if ranges start or stop in the upper half. It is possible to not index the upper triangles by limiting where ranges start and stop (e.g., using whole blocks).

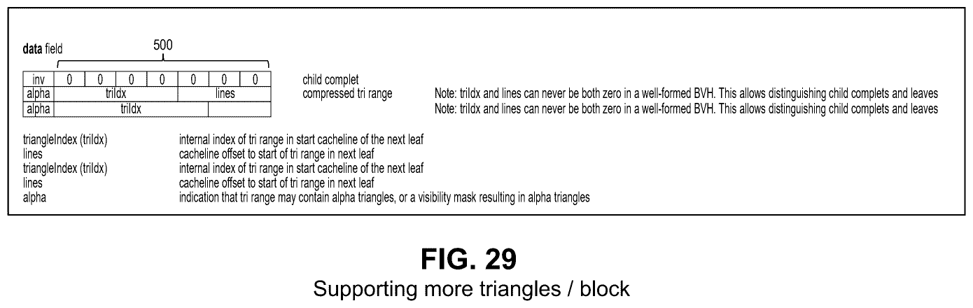

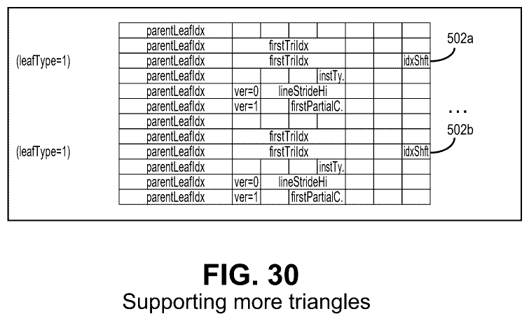

FIGS. 29, 30 show two data structure features added to the complet block in example embodiments. One such feature is simply to provide a sufficient index encoding bits 500 providing for more triangles within a range.

Example embodiments also now provide an additional Index Shift indicator. Here, leafType=a certain value specifies an index shift, with a “idxShift” field 502 indicating that properties of the indices are as specified or have a multiplier on them (e.g., in one example index 5 becomes 10). In one embodiment, all indices are left shifted by 1, i.e., to be even to allow any range to index a sufficient number of triangles without substantially increasing the bit widths required to store triangle indices.

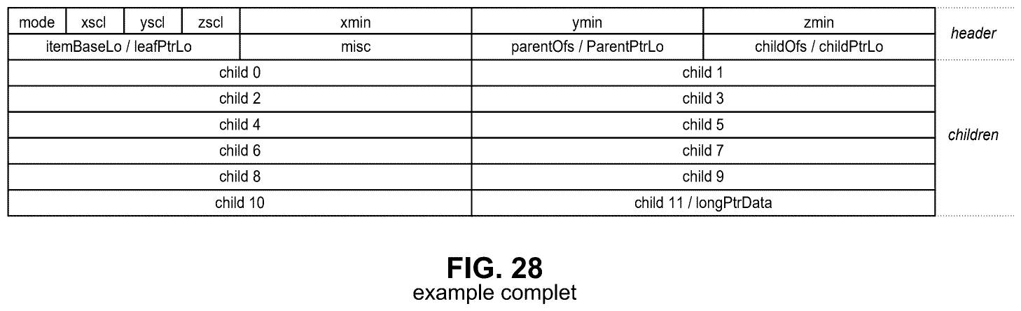

In the example complet, format shown in FIGS. 28, 29 & 30:

The mode field adds an index32prim bit that allows the complet to index up to 32 primitives instead of the usual 16. This increased the size of triIdx, which reduces the number of available lines per range. For the first triangle range in the complet, whose start is specified by the firstTriIdx, an additional firstTriIdexHi field is added to the misc field for the tri range leaf type.

To allow indexing up to 64 primitives, an x2 field is added to the misc field. Since adding more bits to the index would further reduce the number of lines allowed, we instead force the indices to all be powers of 2. E.g., rather than being able to start a range at index 5, it would need to start at index 6 instead. The use of degenerate triangles (either explicit or in the implicit strip topology) can facilitate the correct placement in the block for triangles to start or end the range.

### Stack Entries

The stack entries for triangle ranges are correspondingly expanded to allow indexing up to 64 triangles for the start and end. Bits thus are added for each, the ih and im bits and the ch and em bits as seen in FIG. 31. The separation of these bits from each other and their original positions of triEnd and triIdx is a consequence of iterative design over generations. Again, the exact placement and even the separation is not material. We now have a multibit triIdx and multibit triEnd that define the start and end of the triangle range and can index properly into triangle blocks with up to 64 triangles.

Note that we cannot use the x2 trick for triangle ranges since the range may change and must be exact when dealing with alpha triangles that shorten the triangle range to avoid re-testing the same alpha hit.

### Design Impact

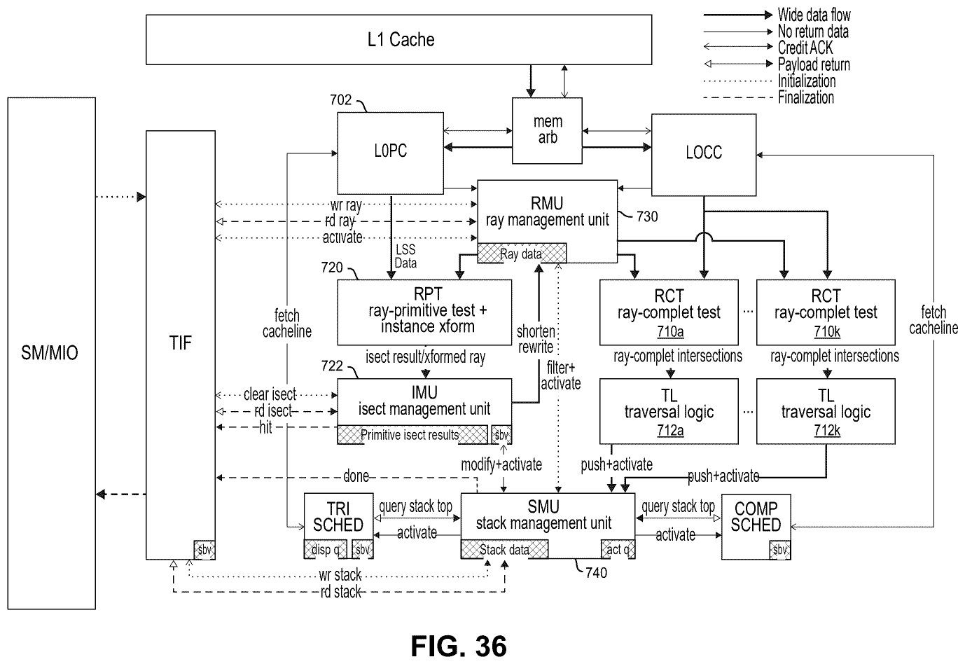

The TTU hardware design (see FIGS. 35, 36) is only impacted in a few locations by these new/added features.

The extra bits for triangle ranges indexing up to 64 triangles in a block that are in the complet are processed in the Traversal Logic (TL) unit and passed to the Stack Management Unit (SMU). From there they are eventually fed into the Ray-Triangle Test (RTT) unit for use in testing triangle ranges.

The RTT unit is also where all decode happens for the triangle block. In the decompression pipe, the arithmetic vertex compression is a simple replacement of the current logical delta swap logic-fitting into the same location but swapping integer adders for logical operations.

The topology compression allowing larger indices uses decompression that tracks larger indices in the block. The primary impact is with the strip topology decode. The strip topology decode is easily done in a sequential fashion, processing all tokens over a small number of cycles added at the front of the decompression pipe, including some optimizations to decode several standard token patterns in parallel in less time (e.g., an [A, LAN, RBN] token sequence can easily be recognized and directly converted to triangles {0, 1, 2}, {0, 2, 3}, and {2, 4, 3} without needing sequential decode).

The following additional discussion is provided for context and completeness.

### Example System Block Diagram

The following describes an overall example non-limiting real time ray tracing system with which the present technology can be used. In particular, while the acceleration structure constructed as described above can be used to advantage by software based graphics pipeline processes running on a conventional general purpose computer, the presently disclosed non-limiting embodiments advantageously implement the above-described techniques in the context of a hardware-based graphics processing unit including a high performance processors such as one or more streaming multiprocessors (“SMs”) and one or more traversal co-processors or “tree traversal units” (“TTUs”)—subunits of one or a group of streaming multiprocessor SMs of a 3D graphics processing pipeline. The following describes the overall structure and operation of such as system including a TTU 138 that accelerates certain processes supporting interactive ray tracing including ray-bounding volume intersection tests, ray-primitive intersection tests and ray “instance” transforms for real time ray tracing and other applications.

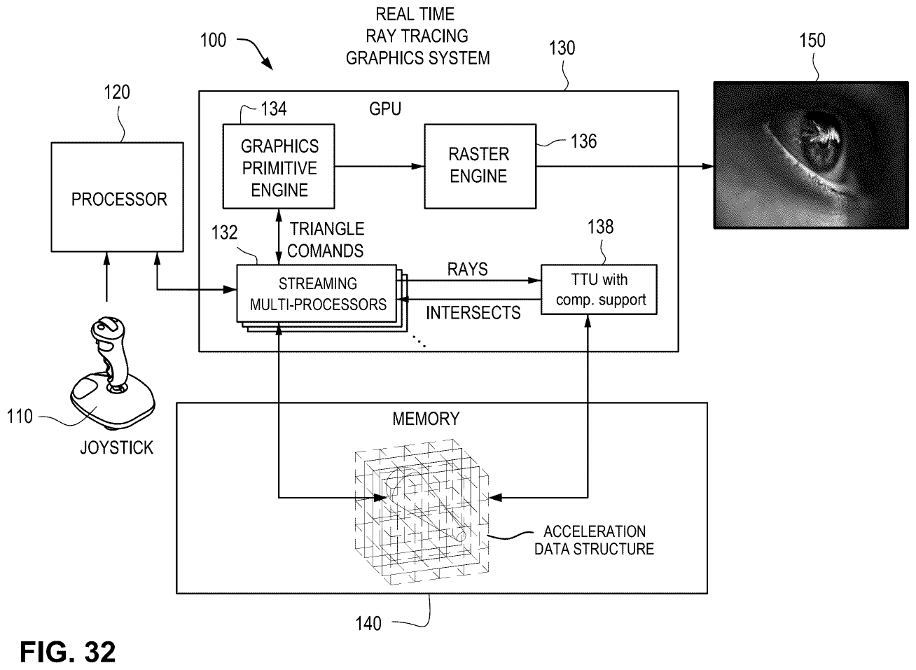

FIG. 32 illustrates a further more detailed example real time interactive ray tracing graphics system 100. System 100 includes an input device 110, a processor(s) 120, a graphics processing unit(s) (GPU(s)) 130, memory 140, and a display(s) 150. The system shown in FIG. 32 can take on any form factor including but not limited to a personal computer, a smart phone or other smart device, a video game system, a wearable virtual or augmented reality system, a cloud-based computing system, a vehicle-mounted graphics system, a system-on-a-chip (SoC), etc.

The processor 120 may be a multicore central processing unit (CPU) operable to execute an application in real time interactive response to input device 110, the output of which includes images for display on display 150. Display 150 may be any kind of display such as a stationary display, a head mounted display such as display glasses or goggles, other types of wearable displays, a handheld display, a vehicle mounted display, etc. For example, the processor 120 may execute an application based on inputs received from the input device 110 (e.g., a joystick, an inertial sensor, an ambient light sensor, etc.) and instruct the GPU 130 to generate images showing application progress for display on the display 150.

Based on execution of the application on processor 120, the processor may issue instructions for the GPU 130 to generate images using 3D data stored in memory 140. The GPU 130 includes specialized hardware for accelerating the generation of images in real time. For example, the GPU 130 is able to process information for thousands or millions of graphics primitives (polygons) in real time due to the GPU's ability to perform repetitive and highly-parallel specialized computing tasks such as polygon scan conversion much faster than conventional software-driven CPUs. For example, unlike the processor 120, which may have multiple cores with lots of cache memory that can handle a few software threads at a time, the GPU 130 may include hundreds or thousands of processing cores or “streaming multiprocessors” (SMs) 132 running in parallel.

In one example embodiment, the GPU 130 includes a plurality of programmable high performance processors that can be referred to as “streaming multiprocessors” (“SMs”) 132, and a hardware-based graphics pipeline including a graphics primitive engine 134 and a raster engine 136. These components of the GPU 130 are configured to perform real-time image rendering using a technique called “scan conversion rasterization” to display three-dimensional scenes on a two-dimensional display 150. In rasterization, geometric building blocks (e.g., points, lines, triangles, quads, meshes, spheres, curves, etc.) of a 3D scene are mapped to pixels of the display (often via a frame buffer memory).

The GPU 130 converts the geometric building blocks (i.e., primitives such as triangles and LSS primitives) of the 3D model into pixels of the 2D image and assigns an initial color value for each pixel. The graphics pipeline may apply shading, transparency, texture and/or color effects to portions of the image by defining or adjusting the color values of the pixels. The final pixel values may be anti-aliased, filtered and provided to the display 150 for display. Many software and hardware advances over the years have improved subjective image quality using rasterization techniques at frame rates needed for real-time graphics (i.e., 30 to 60 frames per second) at high display resolutions such as 4096×2160 pixels or more on one or multiple displays 150.

To enable the GPU 130 to perform ray tracing in real time in an efficient manner, the GPU provides one or more “TTUs” 138 coupled to one or more SMs 132. The TTU 138 includes hardware components configured to perform (or accelerate) operations commonly utilized in ray tracing algorithms. A goal of the TTU 138 is to accelerate operations used in ray tracing to such an extent that it brings the power of ray tracing to real-time graphics application (e.g., games), enabling high-quality shadows, reflections, and global illumination. Results produced by the TTU 138 may be used together with or as an alternative to other graphics related operations performed in the GPU 130.

More specifically, SMs 132 and the TTU 138 may cooperate to cast rays into a 3D model and determine whether and where that ray intersects the model's geometry. Ray tracing directly simulates light traveling through a virtual environment or scene. The results of the ray intersections together with surface texture, viewing direction, and/or lighting conditions are used to determine pixel color values. Ray tracing performed by SMs 132 working with TTU 138 allows for computer-generated images to capture shadows, reflections, and refractions in ways that can be indistinguishable from photographs or video of the real world. Since ray tracing techniques are even more computationally intensive than rasterization due in part to the large number of rays that need to be traced, the TTU 138 is capable of accelerating in hardware certain of the more computationally-intensive aspects of that process.

Given a BVH constructed as described above, the TTU 138 performs a tree search where each node in the tree visited by the ray has a bounding volume for each descendent branch or leaf, and the ray only visits the descendent branches or leaves whose corresponding bound volume it intersects. In this way, TTU 138 explicitly tests only a small number of primitives for intersection, namely those that reside in leaf nodes intersected by the ray. In the example non-limiting embodiments, the TTU 138 accelerates both tree traversal (including the ray-volume tests) and ray-primitive tests. As part of traversal, it can also handle at least one level of instance transforms, transforming a ray from world-space coordinates into the coordinate system of an instanced mesh. In the example non-limiting embodiments, the TTU 138 does all of this in MIMD fashion, meaning that rays are handled independently once inside the TTU.

In the example non-limiting embodiments, the TTU 138 operates as a servant (coprocessor) to the SMs (streaming multiprocessors) 132. In other words, the TTU 138 in example non-limiting embodiments does not operate independently, but instead follows the commands of the SMs 132 to perform certain computationally-intensive ray tracing related tasks much more efficiently than the SMs 132 could perform themselves. In other embodiments or architectures, the TTU 138 could have more or less autonomy.

In the examples shown, the TTU 138 receives commands via SM 132 instructions and writes results back to an SM register file. For many common use cases (e.g., opaque primitives with at most one level of instancing), the TTU 138 can service the ray tracing query without further interaction with the SM 132. More complicated queries (e.g., involving alpha-tested triangles, primitives other than triangles, or multiple levels of instancing) may require multiple round trips (although the technology herein reduces the need for such “round trips” for certain kinds of geometry by providing the TTU 138 with enhanced capabilities to autonomously perform ray-bounding-volume intersection testing without the need to ask the calling SM for help). In addition to tracing rays, the TTU 138 is capable of performing more general spatial queries where an AABB or the extruded volume between two AABBs (which we call a “beam”) takes the place of the ray. Thus, while the TTU 138 is especially adapted to accelerate ray tracing related tasks, it can also be used to perform tasks other than ray tracing.

The TTU 138 thus autonomously performs a test of each ray against a wide range of bounding volumes, and can cull any bounding volumes that don't intersect with that ray. Starting at a root node that bounds everything in the scene, the traversal co-processor tests each ray against smaller (potentially overlapping) child bounding volumes which in turn bound the descendent branches of the BVH. The ray follows the child pointers for the bounding volumes the ray hits to other nodes until the leaves or terminal nodes (volumes) of the BVH are reached.

Once the TTU 138 traverses the acceleration data structure to reach a terminal or “leaf” node (which may be represented by one or multiple bounding volumes) that intersects the ray and contains a geometric primitive, it performs a hardware-accelerated ray-primitive intersection test to determine whether the ray intersects that primitive (and thus the object surface that primitive defines). The ray-primitive test can provide additional information about primitives the ray intersects that can be used to determine the material properties of the surface required for shading and visualization. Recursive traversal through the acceleration data structure enables the traversal co-processor to discover all object primitives the ray intersects, or the closest (from the perspective of the viewpoint) primitive the ray intersects (which in some cases is the only primitive that is visible from the viewpoint along the ray). See e.g., Lefrancois et al, NVIDIA Vulkan Ray Tracing Tutorial, December 2019, https://developer.nvidia.com/rtx/raytracing/vkray

As mentioned above, the TTU 138 also accelerates the transform of each ray from world space into object space to obtain finer and finer bounding box encapsulations of the primitives and reduce the duplication of those primitives across the scene. As described above, objects replicated many times in the scene at different positions, orientations and scales can be represented in the scene as instance nodes which associate a bounding box and leaf node in the world space BVH with a transformation that can be applied to the world-space ray to transform it into an object coordinate space, and a pointer to an object-space BVH. This avoids replicating the object space BVH data multiple times in world space, saving memory and associated memory accesses. The instance transform increases efficiency by transforming the ray into object space instead of requiring the geometry or the bounding volume hierarchy to be transformed into world (ray) space and is also compatible with additional, conventional rasterization processes that graphics processing performs to visualize the primitives.

### Example Ray Tracing Processes

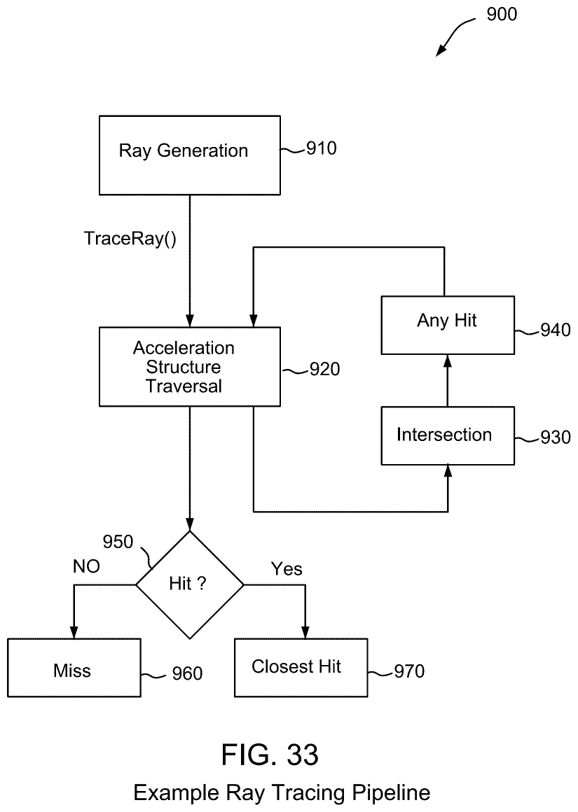

FIG. 33 shows an exemplary ray tracing shading pipeline 900 that may be performed by SM 132 and accelerated by TTU 138. The ray tracing shading pipeline 900 starts by an SM 132 invoking ray generation 910 and issuing a corresponding ray tracing request to the TTU 138. The ray tracing request identifies a single ray cast into the scene and asks the TTU 138 to search for intersections with an acceleration data structure the SM 132 also specifies. The TTU 138 traverses (block 920) the acceleration data structure to determine intersections or potential intersections between the ray and the volumetric subdivisions and associated primitives the acceleration data structure represents. Potential intersections can be identified by finding bounding volumes in the acceleration data structure that are intersected by the ray. Descendants of non-intersected bounding volumes need not be examined.

For triangles and LSS primitives within intersected bounding volumes, the TTU 138 ray-primitive test block 720 performs an intersection 930 process to determine whether the ray intersects the primitives. The TTU 138 returns intersection information to the SM 132, which may perform an “any hit” shading operation 940 in response to the intersection determination. For example, the SM 132 may perform (or have other hardware perform) a texture lookup for an intersected primitive and decide based on the appropriate texel's value how to shade a pixel visualizing the ray. The SM 132 keeps track of such results since the TTU 138 may return multiple intersections with different geometry in the scene in arbitrary order.

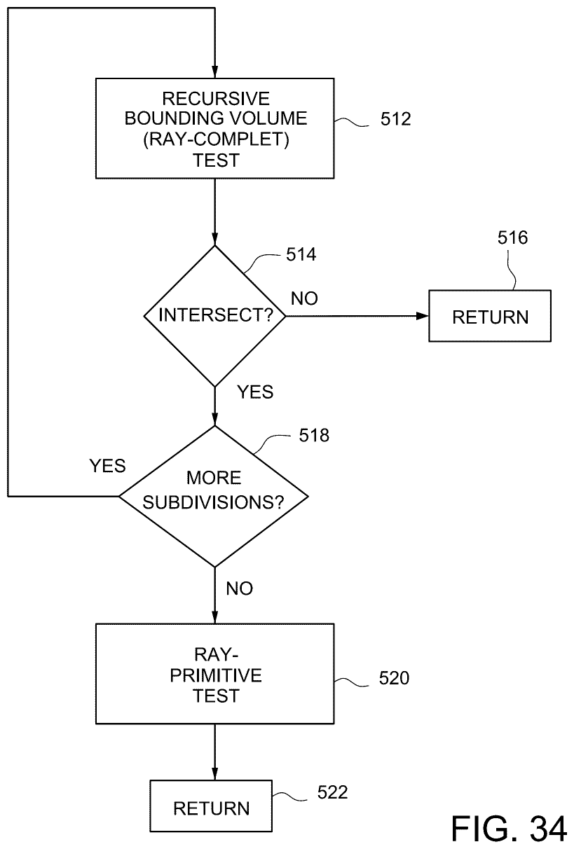

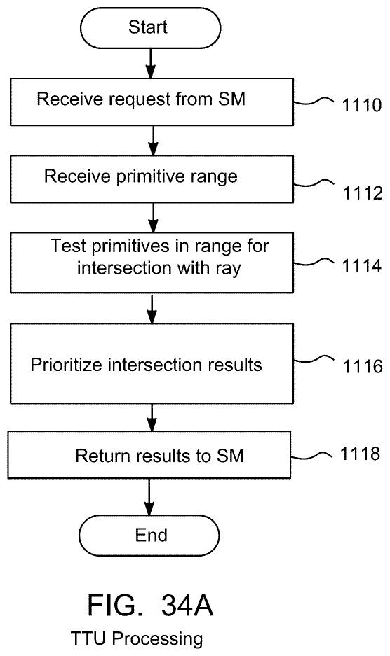

FIG. 34 is a flowchart summarizing example ray tracing operations the TTU 138 performs as described above in cooperation with SM(s) 132. The FIG. 34 operations are performed by TTU 138 in cooperation with its interaction with an SM 132. The TTU 138 may thus receive the identification of a ray from the SM 132 and traversal state enumerating one or more nodes in one or more BVH's that the ray must traverse. The TTU 138 determines which bounding volumes of a BVH data structure the ray intersects (the “ray-complet” test 512). The TTU 138 can also subsequently determine whether the ray intersects one or more primitives in the intersected bounding volumes and which primitives are intersected (the “ray-primitive test” 520)—or the SM 132 can perform this test in software if it is too complicated for the TTU to perform itself. In example non-limiting embodiments, complets specify root or interior nodes (i.e., volumes) of the bounding volume hierarchy with children that are other complets or leaf nodes of a single type per complet.

First, the TTU 138 inspects the traversal state of the ray. If a stack the TTU 138 maintains for the ray is empty, then traversal is complete. If there is an entry on the top of the stack, the traversal co-processor 138 issues a request to the memory subsystem to retrieve that node. The traversal co-processor 138 then performs a bounding box test 512 to determine if a bounding volume of a BVH data structure is intersected by a particular ray the SM 132 specifies (step 512, 514). If the bounding box test determines that the bounding volume is not intersected by the ray (“No” in step 514), then there is no need to perform any further testing for visualization and the TTU 138 can return this result to the requesting SM 132. This is because if a ray misses a bounding volume, then the ray will miss all other smaller bounding volumes inside the bounding volume being tested and any primitives that bounding volume contains.

If the bounding box test performed by the TTU 138 reveals that the bounding volume is intersected by the ray (“Yes” in Step 514), then the TTU determines if the bounding volume can be subdivided into smaller bounding volumes (step 518). In one example embodiment, the TTU 138 isn't necessarily performing any subdivision itself. Rather, each node in the BVH has one or more children (where each child is a leaf or a branch in the BVH). For each child, there is one or more bounding volumes and a pointer that leads to a branch or a leaf node. When a ray processes a node using TTU 138, it is testing itself against the bounding volumes of the node's children. The ray only pushes stack entries onto its stack for those branches or leaves whose representative bounding volumes were hit. When a ray fetches a node in the example embodiment, it doesn't test against the bounding volume of the node—it tests against the bounding volumes of the node's children. The TTU 138 pushes nodes whose bounding volumes are hit by a ray onto the ray's traversal stack in an order determined by ray configuration. For example, it is possible to push nodes onto the traversal stack in the order the nodes appear in memory, or in the order that they appear along the length of the ray, or in some other order. If there are further subdivisions of the bounding volume (“Yes” in step 518), then those further subdivisions of the bounding volume are accessed and the bounding box test is performed for each of the resulting subdivided bounding volumes to determine which subdivided bounding volumes are intersected by the ray and which are not. In this recursive process, some of the bounding volumes may be eliminated by test 514 while other bounding volumes may result in still further and further subdivisions being tested for intersection by TTU 138 recursively applying steps 512-518.

Once the TTU 138 determines that the bounding volumes intersected by the ray are leaf nodes (“No” in step 518), the TTU 138 and/or SM 132 performs a primitive (e.g., triangle or LSS as appropriate) intersection test 520 to determine whether the ray intersects primitives in the intersected bounding volumes and which primitives the ray intersects. The TTU 138 thus performs a depth-first traversal of intersected descendent branch nodes until leaf nodes are reached. The TTU 138 processes the leaf nodes. If the leaf nodes are primitive ranges, the TTU 138 or the SM 132 tests them against the ray. If the leaf nodes are instance nodes, the TTU 138 or the SM 132 applies the instance transform. If the leaf nodes are item ranges, the TTU 138 returns them to the requesting SM 132.

In the example non-limiting embodiments, the SM 132 can command the TTU 138 to perform different kinds of ray-primitive intersection tests and report different results depending on the operations coming from an application (or a software stack the application is running on) and relayed by the SM to the TTU. For example, the SM 132 can command the TTU 138 to report the nearest visible primitive revealed by the intersection test, or to report all primitives the ray intersects irrespective of whether they are the nearest visible primitive. The SM 132 can use these different results for different kinds of visualization. Or the SM 132 can perform the ray-primitive intersection test itself once the TTU 138 has reported the ray-complet test results. Once the TTU 138 is done processing the leaf nodes, there may be other branch nodes (pushed earlier onto the ray's stack) to test.

FIG. 34A shows an example simplified processing flow performed specifically by the TTU 138 in response to SM requests to it, including receiving a request from an SM (1110), receive a primitive range (from a complet as described above and then retrieving and accessing a corresponding triangle block from memory) (1112), testing primitives in the range for intersection with a specified ray (1114), prioritize intersection results if needed (1116), and return intersection results to the SM (1118).

### Example Non-Limiting TTU 138 Hardware Implementation

FIG. 35 shows an example simplified block diagram of TTU 138 including hardware configured to perform accelerated traversal operations as described above, and FIG. 36 shows a more detailed block diagram of TTU 138. In some embodiments, the TTU 138 may perform a depth-first traversal of a bounding volume hierarchy using a short stack traversal with intersection testing of supported leaf node primitives and mid-traversal return of alpha primitives and unsupported leaf node primitives (items). The TTU 138 includes dedicated hardware to determine whether a ray intersects bounding volumes and dedicated hardware to determine whether a ray intersects primitives of the tree data structure. In the example shown, the linear interpolation for ray-bounding box test is performed in the ray-complet test box 710. In example non-limiting embodiments, interpolation for the primitive may be performed in the ray-primitive test box (RPT) 720.

In more detail, TTU 138 includes an intersection management block 722, a ray management block 730 and a stack management block 740. Each of these blocks may constitute dedicated hardware implemented by logic gates, registers, hardware-embedded lookup tables or other combinatorial logic, etc.

The ray management block 730 is responsible for managing information about and performing operations concerning a ray specified by an SM 132 to the ray management block. The stack management block 740 works in conjunction with traversal logic 712 to manage information about and perform operations related to traversal of a BVH acceleration data structure. Traversal logic 712 is directed by results of a ray-complet test block 710 that tests intersections between the ray indicated by the ray management block 730 and volumetric subdivisions represented by the BVH, using instance transforms as needed. The ray-complet test block 710 retrieves additional information concerning the BVH from memory 140 via an L0 complet cache 752 that is part of the TTU 138. The results of the ray-complet test block 710 informs the traversal logic 712 as to whether further recursive traversals are needed. The stack management block 740 maintains stacks to keep track of state information as the traversal logic 712 traverses from one level of the BVH to another, with the stack management block 740 pushing items onto the stack as the traversal logic traverses deeper into the BVH and popping items from the stack as the traversal logic traverses upwards in the BVH. The stack management block 740 is able to provide state information (e.g., intermediate or final results) to the requesting SM 132 at any time the SM requests.

The intersection management block 722 manages information about and performs operations concerning intersections between rays and primitives, using instance transforms as needed. The ray-primitive test block 720 retrieves information concerning geometry from memory 140 on an as-needed basis via an L0 primitive cache 754 that is part of TTU 138. The intersection management block 722 is informed by results of intersection tests the ray-primitive test and transform block 720 performs. Thus, the ray-primitive test and transform block 720 provides intersection results to the intersection management block 722, which reports geometry hits and intersections to the requesting SM 132.

A Stack Management Unit 740 inspects the traversal state to determine what type of data needs to be retrieved and which data path (complet or primitive) will consume it. The intersections for the bounding volumes are determined in the ray-complet test path of the TTU 138 including one or more ray-complet test blocks 710 and one or more traversal logic blocks 712. A complet specifies root or interior nodes of a bounding volume. Thus, a complet may define one or more bounding volumes for the ray-complet test. In example embodiments herein, a complet may define a plurality of “child” bounding volumes that (whether or not they represent leaf nodes) that don't necessarily each have descendants but which the TTU will test in parallel for ray-bounding volume intersection to determine whether geometric primitives associated with the plurality of bounding volumes need to be tested for intersection.

The ray-complet test path of the TTU 138 identifies which bounding volumes are intersected by the ray. Bounding volumes intersected by the ray need to be further processed to determine if the primitives associated with the intersected bounding volumes are intersected. The intersections for the primitives are determined in the ray-primitive test path including one or more ray-primitive test and transform blocks 720 and one or more intersection management blocks 722.

The TTU 138 receives queries from one or more SMs 132 to perform tree traversal operations. The query may request whether a ray intersects bounding volumes and/or primitives in a BVH data structure. The query may identify a ray (e.g., origin, direction, and length of the ray) and a BVH data structure and traversal state (short stack) which includes one or more entries referencing nodes in one or more Bounding Volume Hierarchies that the ray is to visit. The query may also include information for how the ray is to handle specific types of intersections during traversal. The ray information may be stored in the ray management block 730. The stored ray information (e.g., ray length) may be updated based on the results of the ray-primitive test.

The TTU 138 may request the BVH data structure identified in the query to be retrieved from memory outside of the TTU 138. Retrieved portions of the BVH data structure may be cached in the level-zero (L0) cache 750 within the TTU 138 so the information is available for other time-coherent TTU operations, thereby reducing memory 140 accesses. Portions of the BVH data structure needed for the ray-complet test may be stored in a L0 complet cache 752 and portions of the BVH data structure needed for the ray-primitive test (e.g., LSS data blocks as discussed above) may be retrieved from system memory and stored in an L0 primitive cache 754.

After the complet information needed for a requested traversal step is available in the complet cache 752, the ray-complet test block 710 determines bounding volumes intersected by the ray. In performing this test, the ray may be transformed from the coordinate space of the bounding volume hierarchy to a coordinate space defined relative to a complet. The ray is tested against the bounding boxes associated with the child nodes of the complet. In the example non-limiting embodiment, the ray is not tested against the complet's own bounding box because (1) the TTU 138 previously tested the ray against a similar bounding box when it tested the parent bounding box child that referenced this complet, and (2) a purpose of the complet bounding box is to define a local coordinate system within which the child bounding boxes can be expressed in compressed form. If the ray intersects any of the child bounding boxes, the results are pushed to the traversal logic to determine the order that the corresponding child pointers will be pushed onto the traversal stack (further testing will likely require the traversal logic 712 to traverse down to the next level of the BVH). These steps are repeated recursively until intersected leaf nodes of the BVH are encountered.

The ray-complet test block 710 may provide ray-complet intersections to the traversal logic 712. Using the results of the ray-complet test, the traversal logic 712 creates stack entries to be pushed to the stack management block 740. The stack entries may indicate internal nodes (i.e., a node that includes one or more child nodes) that need to be further tested for ray intersections by the ray-complet test block 710 and/or primitives identified in an intersected leaf node that need to be tested for ray intersections by the ray-primitive test and transform block 720. The ray-complet test block 710 may repeat the traversal on internal nodes identified in the stack to determine all leaf nodes in the BVH that the ray intersects. The precise tests the ray-complet test block 710 performs will in the example non-limiting embodiment be determined by mode bits, ray operations (see below) and culling of hits, and the TTU 138 may return intermediate as well as final results to the SM 132.

### Ray-Primitive Intersection Testing

The TTU 138 also has the ability to accelerate intersection tests that determine whether a ray intersects particular geometry or primitives. For some cases, the geometry is sufficiently complex (e.g., certain kinds of procedural geometry such as swept spheres connected by cubic splines) that TTU 138 in some embodiments may not be able to help with the ray-primitive intersection testing. In such cases, the TTU 138 simply reports the ray-complet intersection test results to the SM 132, and the SM 132 performs the ray-primitive intersection test itself. In other cases (e.g., triangle primitives and linear swept sphere primitives), the TTU 138 can perform the ray-primitive intersection test itself in its own hardware circuitry, thereby further increasing performance of the overall ray tracing process. The following describes how the TTU 138 can perform or accelerate the ray-primitive intersection testing.

As explained above, leaf nodes found to be intersected by the ray identify (enclose) primitives that may or may not be intersected by the ray. One option is for the TTU 138 to provide e.g., a range of geometry identified in the intersected leaf nodes to the SM 132 for further processing. For example, the SM 132 may itself determine whether the identified primitives are intersected by the ray based on the information the TTU 138 provides as a result of the TTU traversing the BVH. To offload this processing from the SM 132 and thereby accelerate it using the hardware of the TTU 138, the stack management block 740 may issue requests for the ray-primitive and transform block 720 to perform a ray-primitive test for the primitives within intersected leaf nodes the TTU's ray-complet test block 710 identified. In some embodiments, the SM 132 may issue a request for the ray-primitive test to test a specific range of primitives and transform block 720 irrespective of how that geometry range was identified.

After making sure the primitive data needed for a requested ray-primitive test is available in the primitive cache 754, the ray-primitive and transform block 720 may determine primitives that are intersected by the ray using the ray information stored in the ray management block 730. The ray-primitive test block 720 provides the identification of primitives determined to be intersected by the ray to the intersection management block 722.

The intersection management block 722 can return the results of the ray-primitive test to the SM 132. As noted above, the results of the ray-primitive test may include identifiers of intersected primitives, the distance of intersections from the ray origin and other information concerning properties of the intersected primitives. In some embodiments, the intersection management block 722 may modify an existing ray-primitive test (e.g., by modifying the length of the ray) based on previous intersection results from the ray-primitive and transform block 720.

The intersection management block 722 may also keep track of different types of primitives. For example, the different types of LSS primitives include opaque primitives that will block a ray when intersected and alpha primitives that may or may not block the ray when intersected or may require additional handling by the SM. Whether a ray is blocked or not by a transparent primitive may for example depend on a variety of factors. For example, transparency in some embodiments requires the SM 132 to keep track of transparent object hits so they can be sorted and shaded in ray-parametric order, and typically don't actually block the ray. (Note that in raster graphics, transparency is often called “alpha blending” and trimming is called “alpha test”). In other embodiments, the TTU 138 can push transparent hits to queues in memory for later handling by the SM 132. The intersection management block 722 is configured to maintain a result queue for tracking the different types of intersected primitives. For example, the result queue may store one or more intersected opaque LSS primitive identifiers in one queue and one or more transparent LSS primitive identifiers in another queue.

For transparent primitive, ray intersections cannot in some embodiments be fully determined in the TTU 138 because TTU 138 performs the intersection test based on the geometry of the primitive and may not have access to texture, shading and other information. To fully determine whether the primitive is intersected, information about transparent primitives the ray-primitive and transform block 720 determines are intersected may be sent to the SM 132, for the SM to make the full determination as to whether the transparent primitive affects visibility along the ray.

The SM 132 can resolve whether or not the ray intersects a transparent primitive and/or whether the ray will be blocked by the primitive. The SM 132 may in some cases send a modified query to the TTU 138 (e.g., shortening the ray if the ray is blocked by the primitive) based on this determination. In one embodiment, the TTU 138 may be configured to return all primitives determined to intersect the ray to the SM 132 for further processing. Because returning every primitive intersection to the SM 132 for further processing is costly in terms of interface and thread synchronization, the TTU 138 may be configured to hide primitives which are intersected but are provably capable of being hidden without a functional impact on the resulting scene. For example, because the TTU 138 is provided with primitive type information (e.g., whether a primitive is opaque or transparent), the TTU 138 may use the primitive type information to determine intersected primitives that are occluded along the ray by another intersecting opaque primitive and which thus need not be included in the results because they will not affect the visibility along the ray. If the TTU 138 knows that a primitive is occluded along the ray by an opaque primitive, the occluded primitive can be hidden from the results without impact on visualization of the resulting scene.

The intersection management block 722 may include a result queue for storing hits that associate a primitive ID and information about the point where the ray hit the primitive. When a ray is determined to intersect an opaque primitive, the identity of the primitive and the distance of the intersection from the ray origin can be stored in the result queue. If the ray is determined to intersect another opaque primitive, the other intersected opaque primitive can be omitted from the result if the distance of the intersection from the ray origin is greater than the distance of the intersected opaque primitive already stored in the result queue. If the distance of the intersection from the ray origin is less than the distance of the intersected opaque primitive already stored in the result queue, the other intersected opaque primitive can replace the opaque primitive stored in the result queue. After all of the primitives of a query have been tested, the opaque primitive information stored in the result queue and the intersection information may be sent to the SM 132.

In some embodiments, once an opaque primitive intersection is identified, the intersection management block 722 may shorten the ray stored in the ray management block 730 so that bounding volumes behind the intersected opaque primitive (along the ray) will not be identified as intersecting the ray.

The intersection management block 722 may store information about intersected transparent primitives in a separate queue. The stored information about intersected transparent primitives may be sent to the SM 132 for the SM to resolve visualization issues beyond the current capability of the TTU hardware. The SM may return the results of this determination to the TTU 138 and/or modify the query (e.g., shorten the ray if the ray) based on this determination.

As discussed above, the TTU 138 allows for quick traversal of an acceleration data structure (e.g., a BVH) to determine which primitives in the data structure are intersected by a query data structure (e.g., a ray). For example, the TTU 138 may determine which primitives in the acceleration data structure are intersected by the ray and return the results to the SM 132. However, returning to the SM 132 a result on every primitive intersection is costly in terms of interface and thread synchronization. The TTU 138 provides a hardware logic configured to hide those primitives which are provably capable of being hidden without a functional impact on the resulting scene. The reduction in returns of results to the SM and synchronization steps between threads greatly improves the overall performance of traversal. The example non-limiting embodiments of the TTU 138 disclosed in this application provides for some of the intersections to be discarded within the TTU 138 without SM 132 intervention so that less intersections are returned to the SM 132 and the SM 132 does not have to inspect all intersected primitives or item ranges.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A ray tracer comprising:
a token-based block decoder configured to decode a sequence of tokens specifying polygons in a polygon mesh to determine implicit locations of vertices of the polygons, wherein tokens encode start, direction and an implicit reuse/explicit-new vertex indicator; and
ray-primitive intersection test hardware that tests a polygon range based on the decoded sequence of tokens.

2. The ray tracer of claim 1 wherein the tokens further encode turn back.

3. The ray tracer of claim 1 wherein the tokens further encode rotation.

4. The ray tracer of claim 1 wherein the tokens further encode a degenerate polygon having all vertices the same.

5. The ray tracer of claim 1 wherein the tokens encode at least a 5-bit index to explicitly index up to at least 32 vertices.

6. The ray tracer of claim 1 wherein the decoder is configured to access one, two or three explicit-new vertices from an array based on the implicit reuse/explicit-new vertex indicator.

7. The ray tracer of claim 6 wherein the decoder is further configured to decode explicit-new vertices based on:
a. Per-component shifts and/or
b. Unsigned arithmetic deltas and/or
c. Base vertex shortening.

8. The ray tracer of claim 1 wherein the decoder is configured to access at least up to 64 polygons per cacheline data block.

9. The ray tracer of claim 1 wherein the decoder is configured to access at least up to 64 vertices per cacheline data block.

10. The ray tracer of claim 1 wherein the decoder is configured to use implicit polygon identifiers.

11. The ray tracer of claim 1 wherein the decoder is configured to make all alpha and force-no-cull (“FNC”) bits uniform across all polygons in the range.

12. The ray tracer of claim 1 wherein the decoder is configured to selectively enable or disable opacity micromaps/visibility mask fields.

13. The ray tracer of claim 1 wherein the decoder is configured to perform variable length vertex decompression that preserves polygon clusters that were optimized for a target number of polygons/vertices.

14. A ray tracer acceleration data structure builder comprising:
a token-based block encoder configured to encode a sequence of tokens specifying polygons in a polygon mesh to determine implicit locations of vertices of the polygons, wherein the tokens encode start, direction and an implicit reuse/explicit-new vertex indicator.

15. The ray tracer acceleration data structure builder of claim 14 wherein the tokens further encode turn back.

16. The ray tracer acceleration data structure builder of claim 14 wherein the tokens further encode rotation.

17. The ray tracer acceleration data structure builder of claim 14 wherein the tokens further encode a degenerate polygon having all vertices the same.

18. The ray tracer acceleration data structure builder of claim 14 wherein the tokens encode at least a 5-bit index to explicitly index up to at least 32 vertices.

19. The ray tracer acceleration data structure builder of claim 14 wherein the encoder is configured to encode one, two or three explicit-new vertices from an array based on the implicit reuse/explicit-new vertex indicator.

20. The ray tracer acceleration data structure builder of claim 19 wherein the encoder is further configured to encode explicit-new vertices based on:
a. Per-component shifts and/or
b. Unsigned arithmetic deltas and/or
c. Base vertex shortening.

21. The ray tracer acceleration data structure builder of claim 14 wherein the encoder is configured to access at least up to 64 polygons per cacheline data block.

22. The ray tracer acceleration data structure builder of claim 14 wherein the encoder is configured to access at least up to 64 vertices per cacheline data block.

23. The ray tracer acceleration data structure builder of claim 14 wherein the encoder is configured to use implicit polygon identifiers.

24. The ray tracer acceleration data structure builder of claim 14 wherein the encoder is configured to make all alpha and force-no-cull (“FNC”) bits uniform across all polygons in a range.

25. The ray tracer acceleration data structure builder of claim 14 wherein the encoder is configured to selectively enable or disable opacity micromaps/visibility mask fields.

26. The ray tracer acceleration data structure builder of claim 14 wherein the encoder is configured to perform variable length vertex compression that preserves polygon clusters that were optimized for a target number of polygons/vertices.

27. The ray tracer acceleration data structure builder of claim 14 wherein the encoder encodes a base vertex that is not an actual vertex in a general case but instead comprises a mixture of minimum spatial component values across the polygon range, in order to ensure that all delta compression values used to derive actual vertex components across the range from the base vertex can be unsigned.
